(19) United States
(12) Patent Application Publication
(10) Pub. No.: US 2026/0270655 A1
(43) Pub. Date: Sep. 10, 2026

(54) METHOD AND APPARATUS FOR LOCATION DEPENDENT MULTICAST/BROADCAST SERVICE

(71) Applicant: Telefonaktiebolaget LM Ericsson (publ), Stockholm (SE)

(72) Inventors: Juying GAN, Shanghai (CN); Susana Fernandez ALONSO, Madrid (ES); Meifang ZHU, Lund (SE)

(73) Assignee: Telefonaktiebolaget LM Ericsson (publ), Stockholm (SE)

(21) Appl. No.: 19/472,646

(22) PCT Filed: Apr. 2, 2024
(86) PCT No.: PCT/CN2024/085468

§ 371 Date: Oct. 4, 2025

(30) Foreign Application Priority Data
Apr. 4, 2023 (WO) PCT/CN2023/086231

(51) Int. Cl. H04W 4/06; H04W 4/021

(52) U.S. Cl. CPC H04W 4/06; H04W 4/021

(57) ABSTRACT

A method performed by a MB-SMF may comprise sending an MBS policy control create request for a location dependent MBS session to a PCF receiving an MBS policy control create response for the location dependent MBS session from the PCF. The MBS policy control create request may comprise a MBS session ID and first information. The first information and the MBS session ID may be used to uniquely identify an MBS session towards a specific MBS service area of a location dependent MBS session, and/or create a policy association for the location dependent MBS session corresponding to the MBS session ID and the first information, and/or differentiate different location based services provided via the location dependent MBS session with a same MBS session ID, and/or associate AF session information with the location dependent MBS session in a specific MBS service area, and/or uniquely identify policy information for the location dependent MBS session corresponding to the MBS session ID and the first information.

### TECHNICAL FIELD

The non-limiting and exemplary embodiments of the present disclosure generally relate to the technical field of communications, and specifically to method and apparatus for location dependent multicast/broadcast service (MBS) service.

### BACKGROUND

This section introduces aspects that may facilitate a better understanding of the disclosure. Accordingly, the statements of this section are to be read in this light and are not to be understood as admissions about what is in the prior art or what is not in the prior art.

MBS is a point-to-multipoint service in which data is transmitted from a single source entity to multiple recipients, either to all users in a broadcast service area, or to users in a multicast group. The corresponding types of MBS session are broadcast session and multicast session.

MBS may be one of the most promising fifth generation (5G) applications/services, where the 5G network can be utilized to transmit content to multiple user equipments (UEs). It may be a critical technology for public safety, the automotive industry, etc.

Designing a meaningful and efficient system architecture to enable such a service is critical. Furthermore, policy and charging control (PCC) procedure defines how to handle the 5G MBS (5 MBS) session with proper policies and charging while the MBS service is in use. Therefore, a complete PCC procedure is critical for covering different scenarios and use cases.

Third Generation Partnership Project (3GPP) Technical Specification (TS) 23.247 V18.1.0, the disclosure of which is incorporated by reference herein in its entirety, describes architectural enhancements for 5G (fifth generation) multicast-broadcast services.

FIG. 1A shows an example of delivery methods, which is same as FIG. 4.1-1 of 3GPP TS 23.247V18.1.0 .

The MBS architecture follows the 5G system (5GS) architectural principles as defined in 3GPP TS 23.501V18.0.0 , the disclosure of which is incorporated by reference herein in its entirety, enabling distribution of the MBS data from the 5GS ingress to next generation radio access network (NG-RAN) node(s) and then to the UE. The MBS architecture provides efficient usage of radio access network (RAN) and core network (CN) resources, with an emphasis on radio interface efficiency, and efficient transport for a variety of multicast and broadcast services.

The MBS also provides functionalities such as local MBS service, authorization of multicast MBS and quality of service (QOS) differentiation. MBS traffic may be delivered from a single data source (e.g. Application Service Provider) to multiple UEs. Depending on many factors, there are several delivery methods which may be used to deliver the MBS traffic in the 5GS.

Between 5G core network (5GC) and NG-RAN, there are two possible delivery methods to transmit the MBS data.

The first delivery method is 5GC Individual MBS traffic delivery method. This method is only applied for multicast MBS session. 5GC receives a single copy of MBS data packets and delivers separate copies of those MBS data packets to individual UEs via per-UE protocol data unit (PDU) session. Hence for each such UE one PDU session is required to be associated with a multicast session.

The second delivery method is 5GC shared MBS traffic delivery method. This method is applied for both broadcast and multicast MBS session. 5GC receives a single copy of MBS data packets and delivers a single copy of those MBS packets to an NG-RAN node, which then delivers the packets to one or multiple UEs.

Between the NG-RAN and the UE, two delivery methods are available for the transmission of MBS data packets over radio interface.

The first delivery method is Point-to-Point (PTP) delivery method where NG-RAN delivers separate copies of MBS data packets over radio interface to individual UE(s).

The second delivery method is Point-to-Multipoint (PTM) delivery method where NG-RAN delivers a single copy of MBS data packets over radio interface to multiple UEs.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

A location dependent MBS service is an MBS service provided in several MBS service area(s). An MBS service area may be identified by a cell list or a tracking area list. The MBS service area could be geographical area information or civic address information, and Network Exposure Function (NEF)/Multicast/Broadcast Service Function (MBSF) may translate the location information to Cell identifier (ID) list or Tracking Area Identity (TAI) list as MBS service area, see clause 7.1.1.2 of 3GPP TS 23.247V18.1.0 .

A location dependent MBS may be identified by MBS session ID, and provided in several MBS service areas. The location dependent MBS service enables distribution of different content data to different MBS service areas. The same MBS session ID is used but a different area session ID is used for each MBS service area.

Multiple application function (AFs) may start the same Multicast MBS session with different content in different MBS service areas.

There are several issues identified in MBS PCC procedures for location dependent MBS service (note that “area session” as used herein refers to the location dependent MBS session in an MBS service area).

Issue #1. It is unclear how to handle creation of MBS policy associations for the 2nd, the 3rd . . . area sessions.

The Policy Control Function (PCF) may handle the policy association creation requests for 2nd, the 3rd . . . area sessions as an error situation since there is already a policy association for the same MBS session ID, thus it is expected that the PCF will reject the MBS policy control create request (e.g., Npcf_MBSPolicyControl_Create request) for the 2nd, the 3rd . . . area sessions.

If the PCF, based on implementation, proceeds with policy association creation, there is no way to distinguish which policy association is being updated, etc.

Issue #2. It is unclear how to bind the policy association created by the MBS policy control create request (e.g., Npcf_MBSPolicyControl_Create request) with the policy authorized in MBS policy authorization create request (e.g., Npcf_MBSPolicyAuthorization_Create request) for the same area session when the AF/NEF/MBSF decides to interact with the PCF based on local configuration.

Issue #3. It may fail to create application session context during the MBS policy authorization create (e.g., Npcf_MBSPolicyAuthorization_Create) for the same area session that with the same MBS session ID of a location dependent service.

Therefore the MBS PCC procedures for location dependent MBS service do not work as expected. To overcome or mitigate at least one above mentioned problems or other problems, the embodiments of the present disclosure propose an improved solution for location dependent MBS service.

In an embodiment, to address Issue #1, for each area session, the MB-SMF may provide an additional ID (e.g., area session policy ID) together MBS session ID in MBS policy control create request (such as Npcf_MBSPolicyControl_Create request) to the PCF over N7mb.

In an embodiment, to address Issue #2 and Issue #3, for each area session, an additional ID (e.g., area session policy binding ID) may be assigned when the AF/NEF/MBSF interacts with the PCF, and such ID may be sent by AF/NEF/MBSF to the MB-SMF.

In an embodiment, regarding how the MB-SMF determines area session policy ID, the following is proposed. If AF/NEF/MBSF does not interact with PCF, the MB-SMF may use area session ID as area session policy ID. If AF/NEF/MBSF interacts with PCF, the MB-SMF may use area session policy binding ID as area session policy ID.

In an embodiment, regarding how the area session policy binding ID is assigned when the AF/NEF/MBSF decides to interact with the PCF based on local configuration, the following is proposed.

In an embodiment, the AF/NEF/MBSF may assign an additional ID (e.g., area session policy binding ID) and send it in MBS policy authorization create request (such as Npcf_MBSPolicyAuthorization_Create Request) to PCF.

In an embodiment, the AF/NEF/MBSF may include an area session policy binding ID in MBS session create request (such as Nmbsmf_MBSSession_Create request).

In an embodiment, the MB-SMF may use the area session policy binding ID as area session policy ID in MBS policy control create request (such as Npcf_MBSPolicyControl_Create request) to the PCF so that the PCF can retrieve the policy authorized previously when AF/NEF/MBSF interacted with the PCF.

In an embodiment, the MB-SMF may include the area session policy binding ID in MBS session create response (such as Nmbsmf_MBSSession_Create response) so that the AF/NEF/MBSF knows the relation between the area session ID and the area session policy binding ID.

In an embodiment, in the PCC procedures for location dependent MBS service, the MB-SMF may include a new area session policy ID in MBS policy control create Request (such as Npcf_MBSPolicyControl_Create Request).

In an embodiment, when AF/NEF/MBSF does not interact with the PCF, the MB-SMF may use area session ID as area session policy ID.

In an embodiment, when the AF/NEF/MBSF decides to interact with the PCF e.g. based on local configuration, the AF/NEF/MBSF may assign a new area session policy binding ID and sends it to the PCF.

In an embodiment, the AF/NEF/MBSF may also include the area session policy binding ID in the MBS session create request (such as Nmbsmf_MBSSession_Create request) sent to MB-SMF.

In an embodiment, the MB-SMF may use the area session policy binding ID as area session policy ID and send it to the PCF so that the PCF can retrieve the policy authorized previously when AF/NEF/MBSF interacted with PCF.

In an embodiment, the MB-SMF may include the area session policy binding ID in MBS session create response (such as Nmbsmf_MBSSession_Create response).

In a first aspect of the disclosure, there is provided a method performed a method performed by a multicast/broadcast session management function (MB-SMF). The method may comprise sending a multicast/broadcast service (MBS) policy control create request for a location dependent MBS session to a policy control function (PCF). The method may further comprise receiving an MBS policy control create response for the location dependent MBS session from the PCF. The MBS policy control create request may comprise a MBS session identifier (ID) and first information. The first information and the MBS session ID may be used to uniquely identify an MBS session towards a specific MBS service area of a location dependent MBS session, and/or create a policy association for the location dependent MBS session corresponding to the MBS session ID and the first information, and/or differentiate different location based services provided via the location dependent MBS session with a same MBS session ID, and/or associate application function (AF) session information with the location dependent MBS session in a specific MBS service area, and/or uniquely identify policy information for the location dependent MBS session corresponding to the MBS session ID and the first information.

In an embodiment, the first information may comprise at least one of an ID, or an MBS service area.

In an embodiment, the ID may comprise at least one of a binding ID, or an area session policy ID.

In an embodiment, the binding ID may be assigned by at least one of an AF, a network exposure function (NEF) or a multicast/broadcast service function (MBSF).

In an embodiment, the area session policy ID may comprise at least one of an area session ID, or an area session policy binding ID.

In an embodiment, the area session policy binding ID may be assigned by at least one of an AF, an NEF, an MBSF or the PCF.

In an embodiment, if an MBS policy authorization create request for the location dependent MBS session has not been sent to the PCF, the area session ID may be used as the area session policy ID.

In an embodiment, if the MBS policy authorization create request for the location dependent MBS session has been sent to the PCF, the area session policy binding ID may be used as the area session policy ID.

In an embodiment, the method may further comprise receiving an MBS session create request for the location dependent MBS session from a network function. The method may further comprise sending an MBS session create response for the location dependent MBS session to the network function.

In an embodiment, the MBS session create request may comprise second information and the MBS session ID. The second information and the MBS session ID may be used to uniquely identify an MBS session towards a specific MBS service area of a location dependent MBS session, and/or differentiate different location based services provided via the location dependent MBS sessions with a same MBS session ID, and/or associate application function (AF) session information with the location dependent MBS session in a specific MBS service area.

In an embodiment, the second information may comprise at least one of a binding ID, an area session policy binding ID, or an MBS service area.

In an embodiment, the binding ID may be assigned by at least one of an AF, a network exposure function (NEF) or a multicast/broadcast service function (MBSF). The area session policy binding ID may be assigned by at least one of the AF, the NEF, or the MBSF or the PCF.

In an embodiment, the network function may comprise at least one of an AF, an NEF, or an MBSF.

In an embodiment, the MBS session create response may comprise an area session ID and the second information.

In a second aspect of the disclosure, there is provided a method performed by a PCF. The method may comprise receiving an MBS policy control create request for a location dependent MBS session from an MB-SMF. The method may further comprise sending an MBS policy control create response for the location dependent MBS session to the MB-SMF. The MBS policy control create request may comprise an MBS session ID and first information. The first information and the MBS session ID may be used to uniquely identify an MBS session towards a specific MBS service area of a location dependent MBS session, and/or create a policy association for the location dependent MBS session corresponding to the MBS session ID and the first information, and/or differentiate different location based services provided via the location dependent MBS session with a same MBS session ID, and/or associate application function (AF) session information with the location dependent MBS session in a specific MBS service area, and/or uniquely identify policy information for the location dependent MBS session corresponding to the MBS session ID and the first information, and/or bind the policy association with application session context for the location dependent MBS session corresponding to the MBS session ID and the first information.

In an embodiment, when the MBS policy control create request does not comprise MBS service information, the method may further comprise finding policy information for the location dependent MBS session corresponding to the MBS session ID and the first information.

In an embodiment, when the MBS policy control create request comprises MBS service information and is authorized and at least one required quality of service (QOS) parameter derived based on the MBS service information is allowed, the method may further comprise generating policy information for the location dependent MBS session corresponding to the MBS session ID and the first information. The method may further comprise storing the policy information for the location dependent MBS session corresponding to the MBS session ID and the first information together with the MBS session ID and the first information.

In an embodiment, the first information may comprise at least one of an ID, or an MBS service area.

In an embodiment, the ID may comprise at least one of a binding ID, or an area session policy ID.

In an embodiment, the binding ID may be assigned by at least one of an AF, a network exposure function (NEF), or a multicast/broadcast service function (MBSF).

In an embodiment, the area session policy ID may comprise at least one of an area session ID, or an area session policy binding ID.

In an embodiment, the area session policy binding ID may be assigned by at least one of an AF, an NEF, an MBSF or the PCF.

In an embodiment, if an MBS policy authorization create request for the location dependent MBS session has not been sent to the PCF, the area session ID may be used as the area session policy ID.

In an embodiment, if the MBS policy authorization create request for the location dependent MBS session has been sent to the PCF, the area session policy binding ID may be used as the area session policy ID.

In an embodiment, the method may further comprise receiving an MBS policy authorization create request for the location dependent MBS session from a network function. The MBS policy authorization create request may comprise the second information and the MBS session ID and MBS service information. The method may further comprise sending an MBS policy authorization create response for the location dependent MBS session to the network function. The second information and the MBS session ID may be used to uniquely identify an MBS session towards a specific MBS service area of a location dependent MBS session, and/or differentiate different location based services provided via the location dependent MBS sessions with a same MBS session ID, and/or associate application function (AF) session information with the location dependent MBS session in a specific MBS service area.

In an embodiment, the second information may comprise at least one of a binding ID, an area session policy binding ID, or an MBS service area.

In an embodiment, the binding ID may be assigned by at least one of an AF, a network exposure function (NEF) or a multicast/broadcast service function (MBSF).

In an embodiment, the area session policy binding ID may be assigned by at least one of the AF, the NEF, or the MBSF.

In an embodiment, the method may further comprise receiving an MBS policy authorization create request for the location dependent MBS session from a network function. The MBS policy authorization create request may comprise an MBS service area for a location dependent MBS service and the MBS session ID and MBS service information. The method may further comprise assigning a unique area session policy binding ID for the MBS service area. The unique area session policy binding ID may be used as the second information. The method may further comprise sending an MBS policy authorization create response for the location dependent MBS session to the network function. The MBS policy authorization create response may comprise the unique area session policy binding ID used as the second information.

In an embodiment, when the MBS policy authorization create request is authorized and at least one required QoS parameter derived based on the MBS service information is allowed, the method may further comprise creating an application session context for the location dependent MBS session corresponding to the MBS session ID and the second information. The method may further comprise generating policy information for the location dependent MBS session corresponding to the MBS session ID and the second information. The method may further comprise storing the policy information for the location dependent MBS session corresponding to the MBS session ID and the second information together with the MBS session ID and the second information.

In an embodiment, the network function may comprise at least one of an AF, a network exposure function (NEF), or a multicast/broadcast service function (MBSF).

In a third aspect of the disclosure, there is provided a method performed by a network function. The method may comprise sending an MBS session create request for a location dependent MBS session to an MB-SMF. The method may further comprise receiving an MBS session create response for the location dependent MBS session from the MB-SMF. The MBS session create request may comprise second information and an MBS session ID. The second information and the MBS session ID may be used to uniquely identify an MBS session towards a specific MBS service area of a location dependent MBS session, and/or differentiate different location based services provided via the location dependent MBS session with a same MBS session ID, and/or associate application function (AF) session information with the location dependent MBS session in a specific MBS service area.

In an embodiment, the second information may comprise at least one of a binding ID, an area session policy binding ID, or an MBS service area.

In an embodiment, the binding ID may be assigned by at least one of an AF, a network exposure function (NEF) or a multicast/broadcast service function (MBSF).

In an embodiment, the area session policy binding ID may be assigned by at least one of the AF, the NEF, or the MBSF.

In an embodiment, the MBS session create response may comprise an area session ID and the second information.

In an embodiment, the network function may comprise at least one of an AF, an NEF, or an MBSF.

In an embodiment, when the network function is an NEF or an MBSF, the method may further comprise receiving the MBS session create request for the location dependent MBS session from an AF. The method may further comprise sending the MBS session create response for the location dependent MBS session to the AF.

In an embodiment, when the network function is an AF, sending an MBS session create request for a location dependent MBS session to an MB-SMF may comprise sending the MBS session create request for the location dependent MBS session to the MB-SMF directly, or sending the MBS session create request for the location dependent MBS session to the MB-SMF via an NEF or an MBSF.

The method may further comprise sending an MBS policy authorization create request for the location dependent MBS session to a PCF. The MBS policy authorization create request may comprise the second information and the MBS session ID and MBS service information. The method may further comprise receiving an MBS policy authorization create response for the location dependent MBS session from the PCF. The second information and the MBS session ID may be used to create application session context for the location dependent MBS session corresponding to the MBS session ID and the second information.

In an embodiment, the method may further comprise sending an MBS policy authorization create request for the location dependent MBS session to a PCF. The MBS session create request may comprise an MBS service area for a location dependent MBS service and the MBS session ID and MBS service information. The method may further comprise receive an MBS policy authorization create response for the location dependent MBS session from the PCF. The MBS policy authorization create response may comprise a unique area session policy binding ID used as the second information. The second information and the MBS session ID may be used to create application session context for the location dependent MBS session corresponding to the MBS session ID and the second information.

In an embodiment, when the network function is an NEF or an MBSF, the method may further comprise receiving the MBS policy authorization create request for the location dependent MBS session from an AF. The method may further comprise sending the MBS policy authorization create response for the location dependent MBS session to the AF.

In an embodiment, when the network function is an AF, sending the MBS policy authorization create request for the location dependent MBS session to the PCF may comprise sending the MBS policy authorization create request for the location dependent MBS session to the PCF directly, or sending the MBS policy authorization create request for the location dependent MBS session to the PCF via an NEF or an MBSF.

In a fourth aspect of the disclosure, there is provided an MB-SMF. The MB-SMF may comprise a processor and a memory coupled to the processor. Said memory contains instructions executable by said processor. Said MB-SMF is operative to send a multicast/broadcast service (MBS) policy control create request for a location dependent MBS session to a policy control function (PCF). Said MB-SMF is further operative to receive an MBS policy control create response for the location dependent MBS session from the PCF. The MBS policy control create request may comprise a MBS session identifier (ID) and first information. The first information and the MBS session ID may be used to uniquely identify an MBS session towards a specific MBS service area of a location dependent MBS session, and/or create a policy association for the location dependent MBS session corresponding to the MBS session ID and the first information, and/or differentiate different location based services provided via the location dependent MBS session with a same MBS session ID, and/or associate application function (AF) session information with the location dependent MBS session in a specific MBS service area, and/or uniquely identify policy information for the location dependent MBS session corresponding to the MBS session ID and the first information.

In a fifth aspect of the disclosure, there is provided a PCF. The PCF may comprise a processor and a memory coupled to the processor. Said memory contains instructions executable by said processor. Said PCF is operative to receive an MBS policy control create request for a location dependent MBS session from an MB-SMF. Said PCF is further operative to send an MBS policy control create response for the location dependent MBS session to the MB-SMF. The MBS policy control create request may comprise an MBS session ID and first information. The first information and the MBS session ID may be used to uniquely identify an MBS session towards a specific MBS service area of a location dependent MBS session, and/or create a policy association for the location dependent MBS session corresponding to the MBS session ID and the first information, and/or differentiate different location based services provided via the location dependent MBS session with a same MBS session ID, and/or associate application function (AF) session information with the location dependent MBS session in a specific MBS service area, and/or uniquely identify policy information for the location dependent MBS session corresponding to the MBS session ID and the first information, and/or bind the policy association with application session context for the location dependent MBS session corresponding to the MBS session ID and the first information.

In a sixth aspect of the disclosure, there is provided a network function. The network function may comprise a processor and a memory coupled to the processor. Said memory contains instructions executable by said processor. Said network function is operative to send an MBS session create request for a location dependent MBS session to an MB-SMF. Said network function is further operative to receive an MBS session create response for the location dependent MBS session from the MB-SMF. The MBS session create request may comprise second information and an MBS session ID. The second information and the MBS session ID may be used to uniquely identify an MBS session towards a specific MBS service area of a location dependent MBS session, and/or differentiate different location based services provided via the location dependent MBS session with a same MBS session ID, and/or associate application function (AF) session information with the location dependent MBS session in a specific MBS service area.

In a seventh aspect of the disclosure, there is provided an MB-SMF. The MB-SMF may comprise a first sending module configured to send a multicast/broadcast service (MBS) policy control create request for a location dependent MBS session to a policy control function (PCF). The MB-SMF may comprise a first receiving module configured to receive an MBS policy control create response for the location dependent MBS session from the PCF. The MBS policy control create request may comprise a MBS session identifier (ID) and first information. The first information and the MBS session ID may be used to uniquely identify an MBS session towards a specific MBS service area of a location dependent MBS session, and/or create a policy association for the location dependent MBS session corresponding to the MBS session ID and the first information, and/or differentiate different location based services provided via the location dependent MBS session with a same MBS session ID, and/or associate application function (AF) session information with the location dependent MBS session in a specific MBS service area, and/or uniquely identify policy information for the location dependent MBS session corresponding to the MBS session ID and the first information.

In an embodiment, the MB-SMF may further comprise a second receiving module configured to receive an MBS session create request for the location dependent MBS session from a network function.

In an embodiment, the MB-SMF may further comprise a second sending module configured to send an MBS session create response for the location dependent MBS session to the network function.

In an eighth aspect of the disclosure, there is provided a PCF. The PCF may comprise a first receiving module configured to receive an MBS policy control create request for a location dependent MBS session from an MB-SMF. The PCF may further comprise a first sending module configured to send an MBS policy control create response for the location dependent MBS session to the MB-SMF. The MBS policy control create request may comprise an MBS session ID and first information. The first information and the MBS session ID may be used to uniquely identify an MBS session towards a specific MBS service area of a location dependent MBS session, and/or create a policy association for the location dependent MBS session corresponding to the MBS session ID and the first information, and/or differentiate different location based services provided via the location dependent MBS session with a same MBS session ID, and/or associate application function (AF) session information with the location dependent MBS session in a specific MBS service area, and/or uniquely identify policy information for the location dependent MBS session corresponding to the MBS session ID and the first information, and/or bind the policy association with application session context for the location dependent MBS session corresponding to the MBS session ID and the first information.

In an embodiment, when the MBS policy control create request does not comprise MBS service information, the PCF may comprise a finding module configured to find policy information for the location dependent MBS session corresponding to the MBS session ID and the first information.

In an embodiment, when the MBS policy control create request comprises MBS service information and is authorized and at least one required quality of service (QOS) parameter derived based on the MBS service information is allowed, the PCF may further comprise a first generating module configured to generate policy information for the location dependent MBS session corresponding to the MBS session ID and the first information. The PCF may further comprise a first storing module configured to store the policy information for the location dependent MBS session corresponding to the MBS session ID and the first information together with the MBS session ID and the first information.

In an embodiment, the PCF may further comprise a second receiving module configured to receive an MBS policy authorization create request for the location dependent MBS session from a network function. The MBS policy authorization create request may comprise the second information and the MBS session ID and MBS service information. The PCF may further comprise a second sending module configured to send an MBS policy authorization create response for the location dependent MBS session to the network function. The second information and the MBS session ID may be used to uniquely identify an MBS session towards a specific MBS service area of a location dependent MBS session, and/or differentiate different location based services provided via the location dependent MBS sessions with a same MBS session ID, and/or associate application function (AF) session information with the location dependent MBS session in a specific MBS service area.

In an embodiment, the PCF may further comprise a third receiving module configured to receive an MBS policy authorization create request for the location dependent MBS session from a network function. The MBS policy authorization create request may comprise an MBS service area for a location dependent MBS service and the MBS session ID and MBS service information.

In an embodiment, the PCF may further comprise an assigning module configured to assign a unique area session policy binding ID for the MBS service area. The unique area session policy binding ID is used as the second information.

In an embodiment, the PCF may further comprise a third sending module configured to send an MBS policy authorization create response for the location dependent MBS session to the network function. The MBS policy authorization create response may comprise the unique area session policy binding ID used as the second information.

In an embodiment, when the MBS policy authorization create request is authorized and at least one required QoS parameter derived based on the MBS service information is allowed, the PCF may comprise a creating module configured to create an application session context for the location dependent MBS session corresponding to the MBS session ID and the second information. The PCF may comprise a second generating module configured to generate policy information for the location dependent MBS session corresponding to the MBS session ID and the second information. The PCF may comprise a second storing module configured to store the policy information for the location dependent MBS session corresponding to the MBS session ID and the second information together with the MBS session ID and the second information.

In a ninth aspect of the disclosure, there is provided a network function. The network function may comprise a first sending module configured to send an MBS session create request for a location dependent MBS session to an MB-SMF. The network function may further comprise a first receiving module configured to receive an MBS session create response for the location dependent MBS session from the MB-SMF. The MBS session create request may comprise second information and an MBS session ID. The second information and the MBS session ID may be used to uniquely identify an MBS session towards a specific MBS service area of a location dependent MBS session, and/or differentiate different location based services provided via the location dependent MBS session with a same MBS session ID, and/or associate application function (AF) session information with the location dependent MBS session in a specific MBS service area.

In an embodiment, when the network function is an NEF or an MBSF, the network function may further comprise a second receiving module configured to receive the MBS session create request for the location dependent MBS session from an AF. The network function may further comprise a second sending module configured to send the MBS session create response for the location dependent MBS session to the AF.

In an embodiment, the network function may further comprise a third sending module configured to send an MBS policy authorization create request for the location dependent MBS session to a PCF. The MBS policy authorization create request may comprise the second information and the MBS session ID and MBS service information. The network function may further comprise a third receiving module configured to receive an MBS policy authorization create response for the location dependent MBS session from the PCF. The second information and the MBS session ID may be used to create application session context for the location dependent MBS session corresponding to the MBS session ID and the second information.

In an embodiment, the network function may further comprise a fourth sending module configured to send an MBS policy authorization create request for the location dependent MBS session to a PCF. The MBS session create request may comprise an MBS service area for a location dependent MBS service and the MBS session ID and MBS service information. The network function may further comprise a fourth receiving module configured to receive an MBS policy authorization create response for the location dependent MBS session from the PCF. The MBS policy authorization create response may comprise a unique area session policy binding ID used as the second information. The second information and the MBS session ID may be used to create application session context for the location dependent MBS session corresponding to the MBS session ID and the second information.

In an embodiment, when the network function is an NEF or an MBSF, the network function may further comprise a fifth receiving module configured to receive the MBS policy authorization create request for the location dependent MBS session from an AF. The network function may further comprise a fifth sending module configured to send the MBS policy authorization create response for the location dependent MBS session to the AF.

In a tenth aspect of the disclosure, there is provided a computer-readable storage medium storing instructions which when executed by at least one processor, cause the at least one processor to perform any of the methods according to the first, second or third aspects of the disclosure.

In an eleventh aspect of the disclosure, there is provided a computer program product, comprising instructions which, when executed on at least one processor, cause the at least one processor to perform any of the methods according to the first, second or third aspects of the disclosure.

Many advantages may be achieved by applying the proposed solution according to embodiments of the present disclosure. In some embodiments herein, it can avoid the failure cases of creating application session context and/or policy association. In some embodiments herein, the policy association created by MBS policy control create request with the policy authorized in MBS policy authorization create request for the same area session of a location dependent MBS service can be well bound. In some embodiments herein, there is no significant complexity added to the current procedure. Part of the available information such as area session ID can be reused in the framework. In some embodiments herein, it has good backward compatibility. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1A shows an example of delivery methods;

FIG. 1B shows 5G system architecture for Multicast and Broadcast Service;

FIG. 1C shows 5G system architecture for Multicast and Broadcast Service in reference point representation;

FIG. 1D shows a flowchart of MBS session creation with PCC;

FIG. 2A shows a flowchart of a method according to an embodiment of the present disclosure;

FIG. 2B shows a flowchart of a method according to another embodiment of the present disclosure;

FIG. 3A shows a flowchart of a method according to another embodiment of the present disclosure;

FIG. 3B shows a flowchart of a method according to another embodiment of the present disclosure;

FIG. 3C shows a flowchart of a method according to another embodiment of the present disclosure;

FIG. 3D shows a flowchart of a method according to another embodiment of the present disclosure;

FIG. 3E shows a flowchart of a method according to another embodiment of the present disclosure;

FIG. 4A shows a flowchart of a method according to another embodiment of the present disclosure;

FIG. 4B shows a flowchart of a method according to another embodiment of the present disclosure;

FIG. 4C shows a flowchart of a method according to another embodiment of the present disclosure;

FIG. 4D shows a flowchart of a method according to another embodiment of the present disclosure;

FIG. 4E shows a flowchart of a method according to another embodiment of the present disclosure;

FIG. 5 shows a flowchart of MBS session creation with PCC according to another embodiment of the present disclosure;

FIG. 6 shows a flowchart of MBS session creation with PCC according to another embodiment of the present disclosure;

FIG. 7A shows a flowchart of MBS session creation with PCC according to another embodiment of the present disclosure;

FIG. 7B shows a flowchart of MBS session creation with PCC according to another embodiment of the present disclosure;

FIG. 8A is a block diagram showing an apparatus suitable for practicing some embodiments of the disclosure;

FIG. 8B is a block diagram showing an MB-SMF according to an embodiment of the disclosure;

FIG. 8C is a block diagram showing a PCF according to an embodiment of the disclosure; and

FIG. 8D is a block diagram showing a network function according to an embodiment of the disclosure,

FIG. 9 shows an example of a communication system according to an embodiment of the disclosure;

FIG. 10 shows a UE in accordance with some embodiments;

FIG. 11 shows a network node in accordance with some embodiments;

FIG. 12 is a block diagram of a host according to an embodiment of the disclosure;

FIG. 13 is a block diagram illustrating a virtualization environment in which functions implemented by some embodiments may be virtualized; and

FIG. 14 shows a communication diagram of a host communicating via a network node with a UE over a partially wireless connection according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G, 6G communication protocols, and/or any other protocols either currently known or to be developed in the future.

The term “network device” or “network node” or “network function” refers to any suitable function which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and Mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE(Long Term Evolution)) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

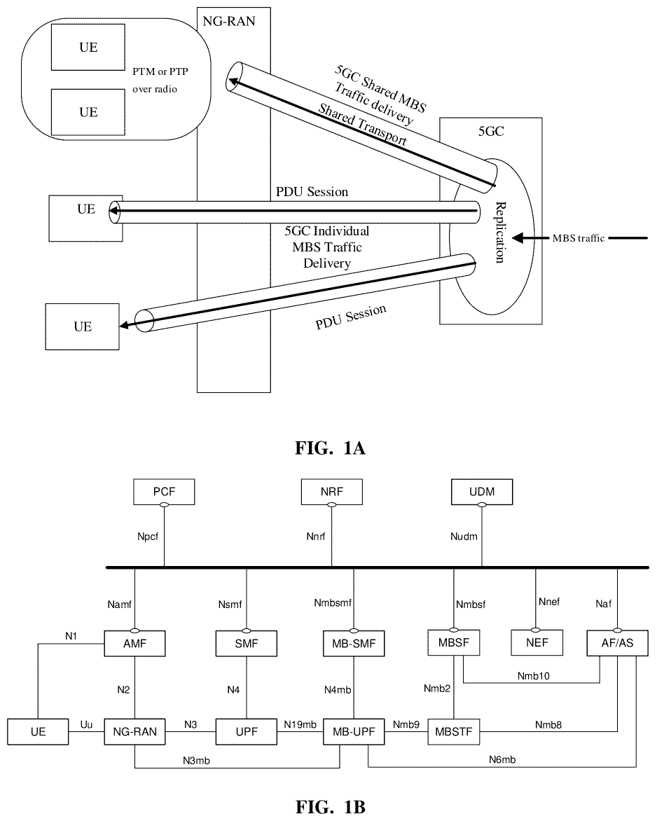

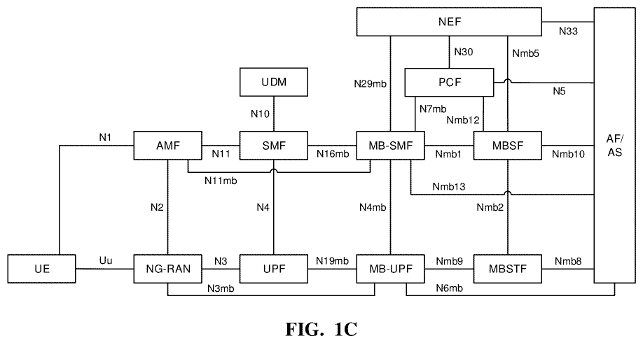

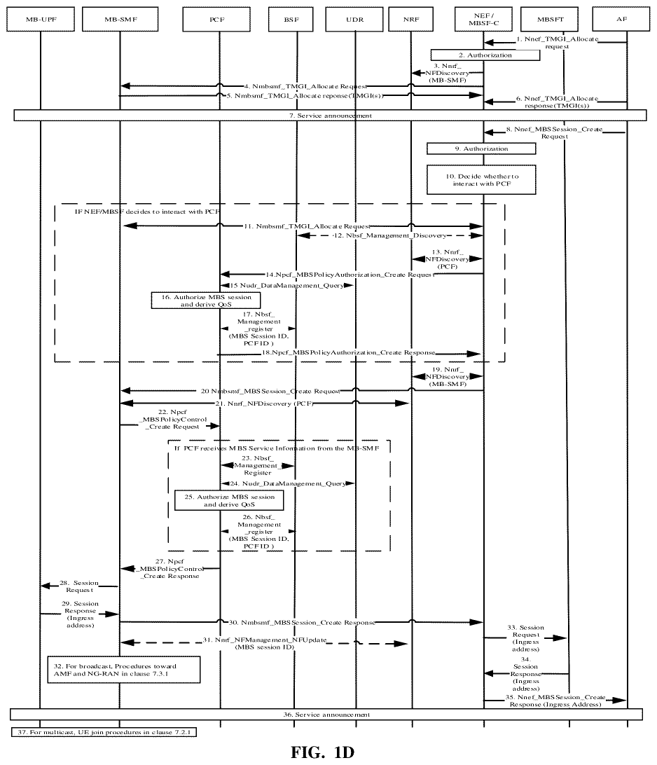

Although the subject matter described herein may be implemented in any appropriate type of system using any suitable components, the embodiments disclosed herein are described in relation to a communication system complied with the exemplary system architecture illustrated in FIG. 1B and FIG. 1C. For simplicity, the system architecture of FIG. 1B and FIG. 1C only depicts some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

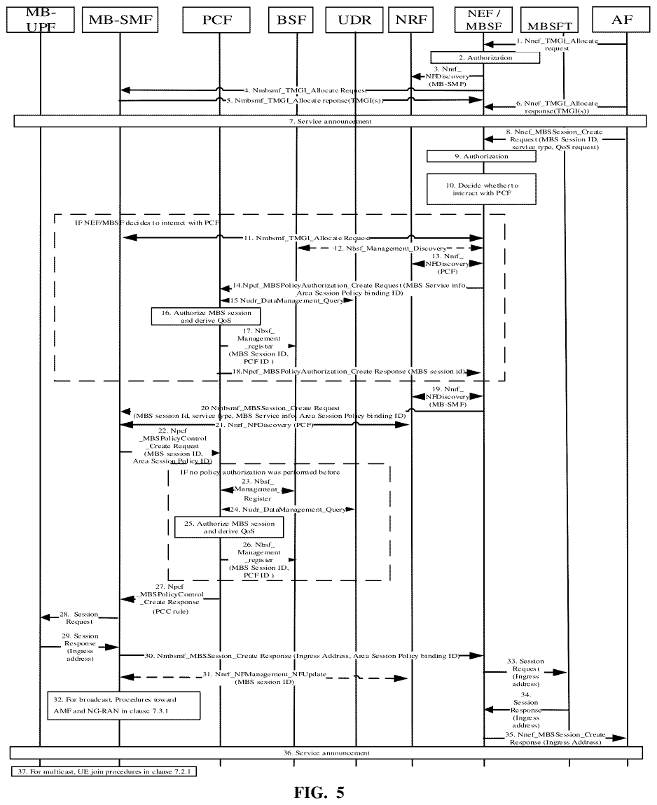

FIG. 1B shows 5G system architecture for Multicast and Broadcast Service, which is same as FIG. 5.1-1 of 3GPP TS 23.247 V18.1.0. FIG. 1C shows 5G system architecture for Multicast and Broadcast Service in reference point representation, which is same as FIG. 5.1-2 of 3GPP TS 23.247 V18.1.0. The 5G MBS system architecture may comprise functional entities such as PCF (Policy Control Function), MB-SMF (Multicast/Broadcast Session Management Function), SMF (Session Management Function), MB-UPF (Multicast/Broadcast User plane Function), UPF (User plane Function), AMF (Access and mobility management function), NG-RAN (next generation radio access network), UE (user equipment), AF/AS (Application Function/Application Server), NEF (Network Exposure Function), MBSF (Multicast/Broadcast Service Function), MBSTF (Multicast/Broadcast Service Transport Function), UDM (Unified Data Management), UDR (Unified Data Repository), NRF (Network Repository Function), etc. These functional entities have been described in clause 5.3.2 of 3GPP TS 23.247 V18.1.0 .

The MBSF is optional and may be collocated with the NEF or AF/AS, and the MBSTF is an optional network function.

The existing service-based interfaces of Nnrf, Nudm, and Nsmf are enhanced to support MBS. The existing service-based interfaces of Npcf and Nnef are enhanced to support MBS.

A MBS-enabled AF uses either Nmbsf or Nnef to interact with the MBSF.

SMF and MB-SMF may be co-located or deployed separately.

The MBS System Architecture may contain the following reference points:

N3mb: Reference point between the (R)AN and the MB-UPF.

N4mb: Reference point between the MB-SMF and the MB-UPF.

N6mb: Reference point between the MB-UPF and the AF/AS.

N7mb: Reference point between the MB-SMF and the PCF.

N11mb: Reference point between the AMF and the MB-SMF.

N16mb: Reference point between the SMF and the MB-SMF.

N19mb: Reference Point between the UPF and the MB-UPF.

N29mb: Reference point between the MB-SMF and the NEF.

Nmb1: Reference point between the MB-SMF and the MBSF.

Nmb2: Reference point between the MBSF and the MBSTF.

Nmb5: Reference point between the MBSF and the NEF.

Nmb8: Reference point between the MBSTF and the AF.

Nmb9: Reference point between the MB-UPF and the MBSTF.

Nmb10: Reference point between the MBSF and the AF.

Nmb12: Reference point between the MBSF and the PCF.

Nmb13: Reference point between the MB-SMF and the AF.

The existing reference points of N1, N2, N4, N10, N11, N30 and N33 are enhanced to support MBS.

Regarding the functionalities, Nmb13, N29mb and Nmb1 are identical, Nmb5 and Nmb10 are identical, Nmb9 and N6mb are identical.

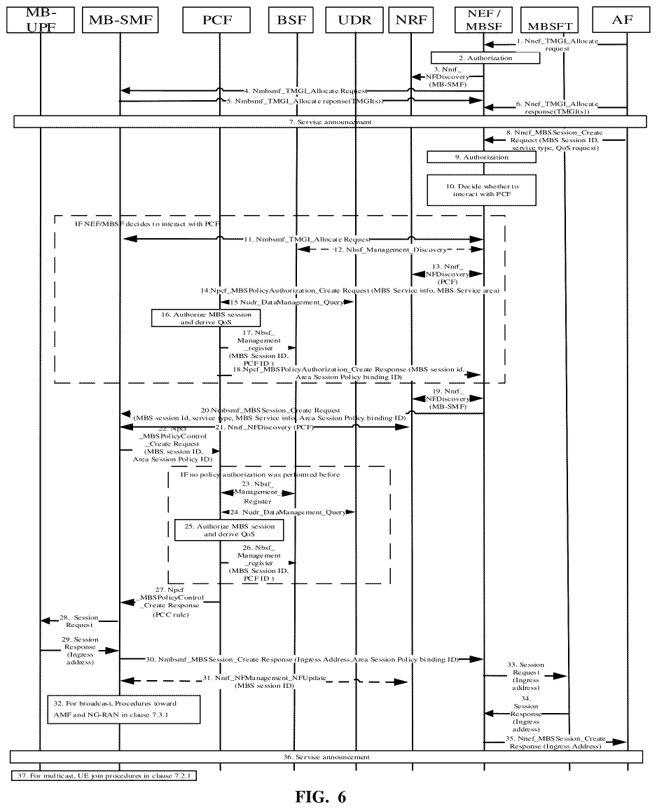

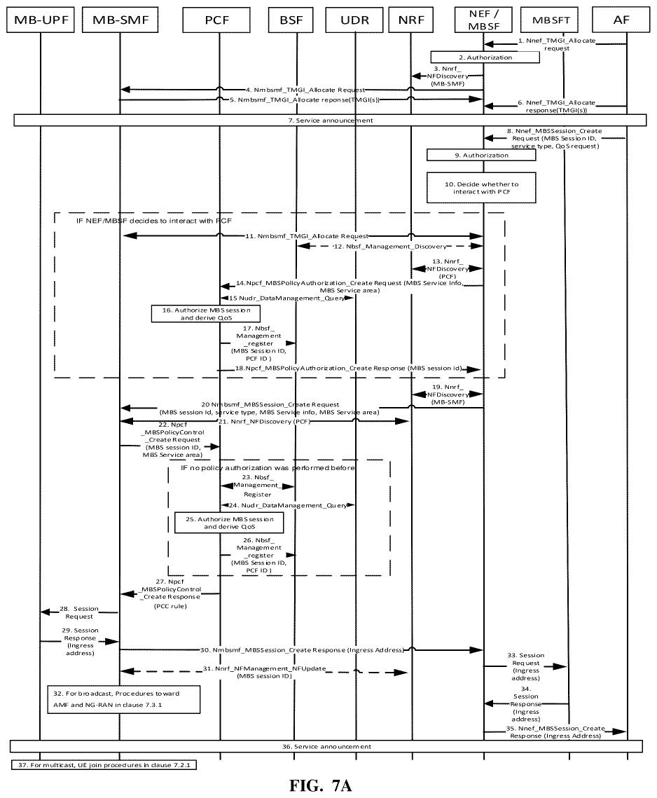

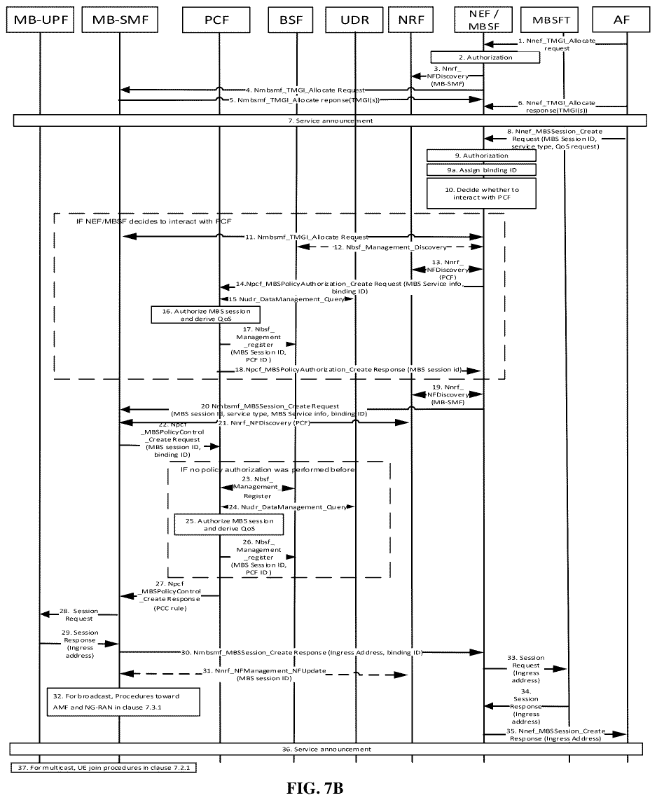

FIG. 1D shows a flowchart of MBS session creation with PCC, which is same as FIG. 7.1.1.3-1 of 3GPP TS 23.247 V18.1.0.

Deployment of dynamic PCC is optional. Clause 7.3.1 of 3GPP TS 23.247 V18.1.0 describes the procedure when dynamic PCC is deployed as following.

Steps 1 to 7 are optional and only applicable if TMGI is used as MBS session ID and required to be pre-allocated.

1 to 9: Same as in FIG. 7.1.1.2-1 of 3GPP TS 23.247 V18.1.0.

10. The NEF/MBSF may optionally, based on local configuration, decide to interact with the PCF.

NOTE 1: In the deployment without NEF and MBSF, the AF optionally interacts with PCF in steps 11-18.

If the NEF/MBSF decided to interact with the PCF, steps 11 to 19 are performed, and in step 20 the MBS Service Information is not provided to the MB-SMF.

If the NEF/MBSF decided not to interact with the PCF, steps 12 to 19 are skipped, and in step 20 the MBS Service Information is provided to the MB-SMF.

11. [Conditional] If the NEF/MBSF did not receive an MBS session ID from the AF in step 8, the NEF/MBSF sends an Nmbsmf_TMGI_Allocate Request (1) message to the MB-SMF and the MB-SMF allocates a TMGI and returns the TMGI to the NEF/MBSF via the Nmbsmf_TMGI_Allocate response (TMGI, expiration time).

12. [Conditional] If the NEF/MBSF receives the Request for location-dependent session from the AF and if there is a need to select the same PCF for the location dependent MBS sessions, the NEF/MBSF first uses the BSF Discovery service to discover whether there is a PCF serving the MBS session with the MBS session ID by using Nbsf_management_Discovery operation. If there is a PCF registered for the MBS session ID, the NEF/MBSF interacts with that PCF and skips the following step 13.

NOTE 2: This step is not necessary in a deployment with a single PCF.

13. [Conditional] If step 12 was not executed or the interaction with the BSF revealed that no PCF is registered for the MBS session ID, the NEF/MBSF discovers the PCF candidates by interacting with the NRF and selects a PCF, possibly based on MBS service area.

14. The NEF/MBSF sends an Npcf_MBSPolicy_Authorization_Create Request (MBS session ID, MBS Service Information (as defined in clause 6.14 of 3GPP TS 23.247V18.1.0 )) to the PCF.

15. [Optional] The PCF may retrieve authorization information for the MBS session from the UDR (see clause 6.10.2 of 3GPP TS 23.247V18.1.0 ) and takes it into account for the subsequent authorization and QoS allowance check.

NOTE 3: This step is not necessary in a deployment with a single PCF if authorization data are stored in the PCF.

16. The PCF determines whether the request is authorized and if the request is authorized, the PCF derives the required QoS parameters based on the received MBS Service Information and determines whether this QoS is allowed. If the required QoS is allowed, the PCF generates the policy information for the MBS session (as defined in clause 6.10 of 3GPP TS 23.247V18.1.0 ) and stores it together with the MBS session ID.

17. If the request is authorized and the required QoS is allowed, the PCF registers at the BSF that it handles the MBS session by using Nbsf_management_Register Request (MBS session ID, PCF ID). It provides an identifier that the policy association is for MBS and the MBS session ID, its own PCF ID and optionally its PCF set ID.

NOTE 4: This step is not necessary in a deployment with a single PCF.

18. The PCF sends an Npcf_MBSPolicy_Authorization_Create Response (Result indication) to the NEF/MBSF.

If the request is not authorized or the required QoS is not allowed, the PCF indicates so in the response to the NEF/MBSF which in turn informs the AF about it (by sending the Nnef_MBSSession_Create response) and ends this procedure.

19. Same as step 10 in FIG. 7.1.1.2-1 of 3GPP TS 23.247 V18.1.0.

20. Same as step 11 in FIG. 7.1.1.2-1 of 3GPP TS 23.247 V18.1.0 with the difference that the MBS Service Information is not present if the optional interaction between AF/NEF/MBSF and PCF has been performed (as the MBS Service Information was provided to the PCF in step 14).

21. The MB-SMF discovers the PCF using NRF.

22. The MB-SMF sends an Npcf_MBSPolicyControl_Create Request (MBS session ID, [MBS Service Information (as defined in clause 6.14 of 3GPP TS 23.247V18.1.0 )]) for the MBS session towards the PCF. The MB-SMF forwards the MBS Service Information to the PCF if received from the NEF/MBSF in the previous step 20.

If PCF receives MBS Service Information from the MB-SMF, the PCF performs the subsequent steps 23 to 26. If the PCF does not receive MBS Service Information from the MB-SMF, but has previously determined policy information for the MBS session (see step 16) corresponding to the MBS session ID received from the MB-SMF, the PCF continues with step 27.

23. If the PCF is not handling the MBS session ID, the PCF uses the BSF Register service to check whether there is already a PCF serving the MBS session. If so, the PCF skips steps 24 to 26 and indicates in step 27 that the PCF serving the MBS session shall be contacted.

NOTE 5: This step is not necessary in a deployment with a single PCF.

24. [Optional] The PCF may retrieve authorization information for the MBS session from the UDR (see clause 6.10.2 of 3GPP TS 23.247V18.1.0 ) and takes it into account for the subsequent authorization and QoS allowance check.

NOTE 6: This step is not necessary if authorization data are stored in the PCF.

25. The PCF determines whether the request is authorized and if the request is authorized, the PCF derives the required QoS parameters based on the received MBS Service Information and determines whether this QoS is allowed. If the required QoS is allowed, the PCF generates the policy information for the MBS session (as defined in clause 6.10 of 3GPP TS 23.247V18.1.0 ) and stores it together with the MBS session ID.

26. If the request is authorized and the required QoS is allowed the PCF registers at the BSF that it handles the MBS session by using Nbsf_management_Register Request (MBS session ID, PCF ID). It provides an identifier that the policy association is for MBS and the MBS session ID, its own PCF ID and optionally its PCF set ID.

NOTE 7: This step is not necessary in a deployment with a single PCF.

27. The PCF responds with Npcf_MBSPolicyControl_Create Response ([policy information for the MBS session (as defined in clause 6.10 of 3GPP TS 23.247V18.1.0 )], Result indication).

If the request is not authorized or the required QoS is not allowed, the PCF indicates so in the response to the MB-SMF which in turn informs the AF about it (by sending the Nmbsmf_MBSSession_Create response) and ends this procedure.

If another PCF is serving the MBS session, the PCF indicates that another PCF serving the MBS session shall be contacted and provides an ID of that other PCF. The MB-SMF then repeats step 22 towards that other PCF.

28-37: Same as steps 14-22 in FIG. 7.1.1.2-1 of 3GPP TS 23.247 V18.1.0.

NOTE 8: Steps 33-36 can be executed in parallel to step 32.

Below is a short summary of the MBS creation with PCC procedure, which may cover two deployment scenarios.

Deployment-1: AF/NEF/MBSF interacts with the PCF e.g. based on local configuration, and then MB-SMF interacts with PCF.

Deployment-2: Only MB-SMF interacts with PCF (i.e. AF/NEF/MBSF does not interact with the PCF).

When the AF/NEF/MBSF decides to interact with the PCF and if the MBS session corresponds to a location dependent service, the AF/NEF/MBSF will check with Binding Support Function (BSF) if the PCF already handling that MBS session ID exists.

If existing, AF/NEF/MBSF will initiate the Npcf_MBSPolicyAuthorization Create request with that PCF.

If not existing, the AF/NEF/MBSF will ask NRF to select a PCF instance. If the Npcf_MBSPolicyAuthorization_Create request as described in 3GPP TS 23.247 V18.1.0 from the AF/NEF/MBSF is authorized and the required QoS is allowed, the PCF will register at the BSF by using Nbsf_Management_Register_Request (MBS session ID, PCF ID) as described in 3GPP TS 23.502V18.0.0.

When the MB-SMF needs to interact with PCF, the MB-SMF may discover the PCF using NRF and send the Npcf_MBSPolicyControl request as described in 3GPP TS 23.247 V18.1.0 to that PCF ID. If this PCF is not handling the MBS session, then the PCF contacts the BSF (step 23) to register itself in BSF. The PCF responds with Npcf_MBSPolicyControl_Create response to continue the procedure with the PCF ID.

There are several problems identified in MBS PCC procedures for location dependent MBS service.

As a first problem, it may fail to create MBS policy association by MB-SMF for location dependent MBS service with the same MBS session ID. For example, this problem may apply to both Deployment-1 and Deployment-2.

If a PCF has created policy association with an MBS session ID for a location dependent session in the first MBS service area, when the MB-SMF invokes Npcf_MBSPolicyControl_Create request with the PCF for the location dependent MBS session with the same MBS session ID for the second MBS service area, it is expected that the PCF will reject the request due to the fact the policy association for this MBS session ID exists. If the PCF, based on implementation, accepts the second request, there will be no way to distinguish between both policy associations for next interactions.

As a second problem, it may fail to create application session context by AF/NEF/MBSF for location dependent MBS service with the same MBS session ID. For example, this problem may apply to Deployment-1.

If a PCF has created application session context with an MBS session ID for the location dependent session in the first MBS service area, when the AF/NEF/MBSF decides to interact with the PCF for the location dependent MBS session with the same MBS session ID for the second MBS service area, the PCF would reject this request and indicate that the MBS application session context already exists for that MBS session ID. Alternatively, it could create another application session context, but then the PCF would have no means to bind the policy context with the application session context.

As a third problem, there is no mechanism to bind the policy association created by Npcf_MBSPolicyControl_Create request with the policy authorized in Npcf_MBSPolicyAuthorization_Create request for the same area session of a location dependent MBS service when the AF/NEF/MBSF decides to interact with the PCF e.g. based on local configuration. For example, this problem may apply to Deployment-1.

For example, upon reception of Npcf_MBSPolicyAuthorization_Create requests from the AF/NEF/MBSF for location dependent MBS session in MBS Service Area 1 (short as “area session 1”) and location dependent MBS session in MBS service area 2 (short as “area session 2”), if the PCF created two application session contexts and derived corresponding policies and when the MB-SMF creates the MBS policy associations for area session 1 and area session 2 above, currently, there is no mechanism for PCF to fetch the policy that the PCF derived earlier for an area session.

To overcome or mitigate at least one of above mentioned problems or other problems, the embodiments of the present disclosure propose an improved solution for the location dependent MBS service.

In an embodiment, it may introduce the area session policy binding ID together with area session policy ID or MBS service area or an identifier that uniquely identifies a session towards a specific MBS service area with the same MBS session ID to differentiate the service areas of a location dependent MBS service and ensure that the Npcf_MBSPolicyAuthorization and Npcf_MBSPlolicyControl requests for different location based services with the same MBS session ID end up in the same PCF.

In an embodiment, it may introduce additional attribute/information/identifier to the MBS creation procedure with PCC for a location dependent MBS service to ensure a complete procedure and avoid failure cases.

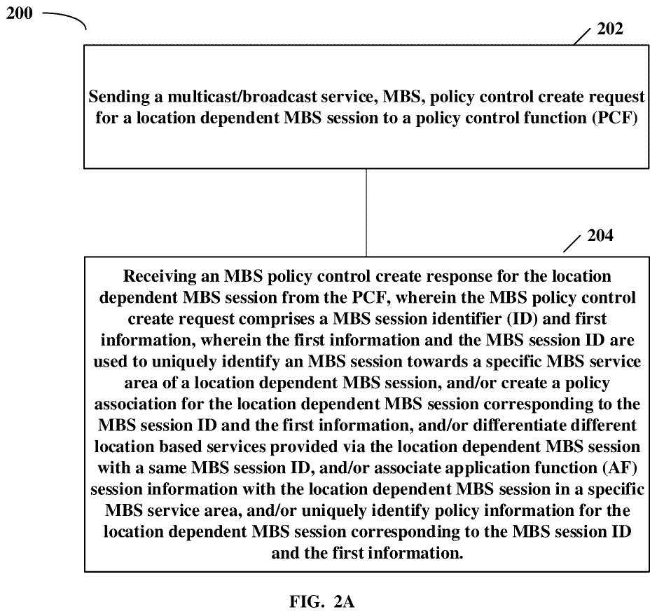

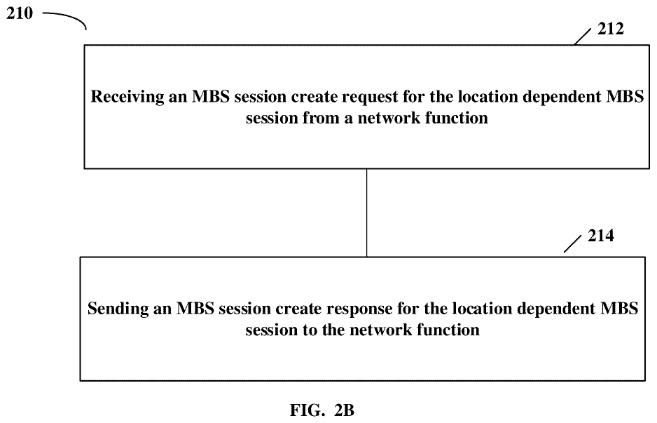

FIG. 2A shows a flowchart of a method according to an embodiment of the present disclosure, which may be performed by an apparatus implemented in/as or communicatively coupled to a multicast/broadcast session management function (MB-SMF). As such, the apparatus may provide means for accomplishing various parts of the method 200 as well as means for accomplishing other processes in conjunction with other components.

At block 202, the MB-SMF may send a multicast/broadcast service (MBS) policy control create request for a location dependent MBS session to a policy control function (PCF).

In an embodiment, the MBS policy control create request may comprise a MBS session identifier (ID) and first information.

In an embodiment, the first information and the MBS session ID may be used (e.g., by MB-SMF, etc.) to uniquely identify an MBS session towards a specific MBS service area of a location dependent MBS session, and/or create a policy association for the location dependent MBS session corresponding to the MBS session ID and the first information, and/or differentiate different location based services provided via the location dependent MBS session with a same MBS session ID, and/or associate application function (AF) session information with the location dependent MBS session in a specific MBS service area, and/or uniquely identify policy information for the location dependent MBS session corresponding to the MBS session ID and the first information.

The MB-SMF may be any suitable node or entity or function which can implement Multicast/Broadcast (MB) session management function. In an embodiment, the MB-SMF may be MB-SMF or Multimedia Broadcast/Multicast Service gateway (MBMS GW) as described in 3GPP TS 23.247V18.1.0 .

The PCF may be any suitable node or entity or function which can implement policy control function. In an embodiment, the PCF may be PCF as described in 3GPP TS 23.247 V18.1.0 or PCRF as described in 3GPP TS 23.401 V18.0.0 .

The location dependent MBS session may be same or similar as/to the location dependent MBS session as described in 3GPP TS 23.247 V18.1.0 .

The MBS policy control create request may be an existing message or a new message. In an embodiment, the MBS policy control create request may be an Npcf_MBSPolicyControl_Create Request for example as described in 3GPP TS 23.247 V18.1.0 .

The MBS session ID may be used to identify a Multicast/Broadcast MBS session by the communication system (such as 5GS) on external interface towards AF and between AF and UE, and towards the UE. The MBS session ID may have the following types: temporary mobile group identity (TMGI) (for broadcast and multicast MBS sessions) and/or source specific Internet protocol (IP) multicast address (for multicast MBS sessions). In an embodiment, the MBS session ID may be same or similar to the MBS session ID as described in 3GPP TS 23.247 V18.1.0.

The first information may be of any suitable form and the present disclosure has no limit on it. For example, the first information may be an identifier, an MBS service area, etc.

The first information may be obtained in various ways and the present disclosure has no limit on it. For example, the first information may be assigned/allocated by at least one of an AF, a network exposure function (NEF), a multicast/broadcast service function (MBSF) or the PCF or the MB-SMF.

In an embodiment, the first information may comprise at least one of an ID or an MBS service area. The ID may be any suitable ID and the present disclosure has no limit on it. For each service area of a location dependent MBS service, the AF/NEF/MBSF/PCF can tag it with a unique identifier, for example, an AF ID plus a unique string or timestamp plus a unique string. The MBS service area may be the area within which data of one Multicast or Broadcast MBS session may be sent. For location dependent MBS, for each MBS service area, an area session ID, which is unique per MBS session ID, is allocated and the same location dependent content data for an MBS session is delivered to the UE(s) within an MBS service area.

In an embodiment, the ID may comprise at least one of a binding ID or an area session policy ID. The binding ID may be any suitable ID and the present disclosure has no limit on it. For each service area of a location dependent MBS service, the AF/NEF/MBSF can tag it with a unique identifier, for example, an AF ID plus a unique string or timestamp plus a unique string.

In an embodiment, the binding ID may be assigned by at least one of an AF, a network exposure function (NEF), or a multicast/broadcast service function (MBSF).

The area session policy ID may be any suitable ID and the present disclosure has no limit on it. In an embodiment, the area session policy ID may be assigned by MB-SMF.

In an embodiment, the area session policy ID may comprise at least one of an area session ID or an area session policy binding ID. The area session policy ID may be a unique identifier within an MBS session used for an MBS session with location dependent content. When present, the area session ID, together with the MBS session ID such as TMGI, is used to uniquely identify the data flow of an MBS session in a specific MBS service area. The area session policy binding ID may be any suitable ID and the present disclosure has no limit on it.

In an embodiment, the area session policy binding ID may be assigned by at least one of an AF, an NEF, an MBSF or the PCF.

In an embodiment, if an MBS policy authorization create request for the location dependent MBS session has not been sent to the PCF (e.g., if the AF/NEF/MBSF does not interact with the PCF), the area session ID may be used as the area session policy ID.

In an embodiment, if the MBS policy authorization create request for the location dependent MBS session has been sent to the PCF (e.g., if the AF/NEF/MBSF interacts with the PCF), the area session policy binding ID may be used as the area session policy ID.

In an embodiment, when the MB-SMF receives the binding ID or the area session policy binding ID from the network function, the binding ID or the area session policy binding ID may be used as the area session policy ID.

In an embodiment, when the MB-SMF receives the MBS service area from the network function, the MB-SMF may generate the area session policy ID based on the MBS service area. Alternatively, the MBS service area may be used as the area session policy ID.

At block 204, the MB-SMF may receive an MBS policy control create response for the location dependent MBS session from the PCF.

The MBS policy control create response may comprise any suitable information such as policy information for the location dependent MBS session and result indication, etc.

The MBS policy control create response may be an existing message or a new message. In an embodiment, the MBS policy control create response may be an Npcf_MBSPolicyControl_Create response for example as described in 3GPP TS 23.247 V18.1.0.

FIG. 2B shows a flowchart of a method according to another embodiment of the present disclosure, which may be performed by an apparatus implemented in/as or communicatively coupled to the MB-SMF. As such, the apparatus may provide means for accomplishing various parts of the method 210 as well as means for accomplishing other processes in conjunction with other components. For some parts which have been described in the above embodiments, the description thereof is omitted here for brevity.

At block 212, the MB-SMF may receive an MBS session create request for the location dependent MBS session from a network function.

In an embodiment, after the MB-SMF receives the MBS session create request for the location dependent MBS session from a network function at block 212, it may send an MBS policy control create request for a location dependent MBS session to the PCF at block 202 of FIG. 2A.

The network function may be any suitable network function for example as described in various 3GPP specifications such as 3GPP TS 23.501 V18.0.0 , 3GPP TS 23.682 V17.3.0 , 3GPP TS 23.247 V18.1.0 .

In an embodiment, the network function may comprise at least one of an AF, an NEF, or an MBSF.

The AF may be any suitable node which can provide similar or same function as the AF as described in 3GPP TS 23.501 V18.0.0 or the Application Server (AS) or Services Capability Server (SCS) as described in 3GPP TS 23.682 V17.3.0 . For example, the application node may be a content provider or a multicast source or a broadcast source.

The NEF may be any suitable node which can provide similar or same function as the NEF as described in 3GPP TS 23.501 V18.0.0 or the Service Capability Exposure Function (SCEF) as described in 3GPP TS 23.682 V17.3.0 .

The MBSF may be any suitable node which can provide similar or same function as the MBSF as described in 3GPP TS 23.501 V18.0.0 or the Broadcast Multicast Service Centre (BM-SC) as described in 3GPP TS 23.682 V17.3.0 .

The MBS session create request may be an existing message or a new message. In an embodiment, the MBS session create request may be an Nmbsmf_MBSSession_Create Request for example as described in 3GPP TS 23.247 V18.1.0 .

In an embodiment, the MBS session create request may comprise second information and the MBS session ID.

In an embodiment, the second information and the MBS session ID may be used to uniquely identify an MBS session towards a specific MBS service area of a location dependent MBS session, and/or differentiate different location based services provided via the location dependent MBS sessions with a same MBS session ID, and/or associate application function (AF) session information with the location dependent MBS session in a specific MBS service area.

The second information may be any suitable information and the present disclosure has no limit on it. In an embodiment, the second information may comprise at least one of a binding ID, an area session policy binding ID, or an MBS service area.

In an embodiment, the binding ID may be assigned by at least one of an AF, an NEF, or a MBSF.

In an embodiment, the area session policy binding ID may be assigned by at least one of the AF, the NEF, or the MBSF or the PCF.

At block 214, the MB-SMF may send an MBS session create response for the location dependent MBS session to the network function.

In an embodiment, after the MB-SMF receives an MBS policy control create response for the location dependent MBS session from the PCF at block 204, it may send an MBS session create response for the location dependent MBS session to the network function at block 214 of FIG. 2A.

The MBS session create response may be an existing message or a new message. In an embodiment, the MBS session create response may be an Nmbsmf_MBSSession Create response for example as described in 3GPP TS 23.247 V18.1.0 .

The MBS session create response may comprise any suitable information such as an ingress address (Internet protocol (IP) address and port).

In an embodiment, the MBS session create response may comprise an area session ID and the second information.

In an embodiment, if the network function such as AF/NEF/MBSF has the mechanism to associate the area session ID and the second information such as the binding ID when receiving MBS session create response such as Nmbsmf_MBSSession_Create response, there is no need to send back the second information such as the binding ID in the response for the location dependent MBS service.

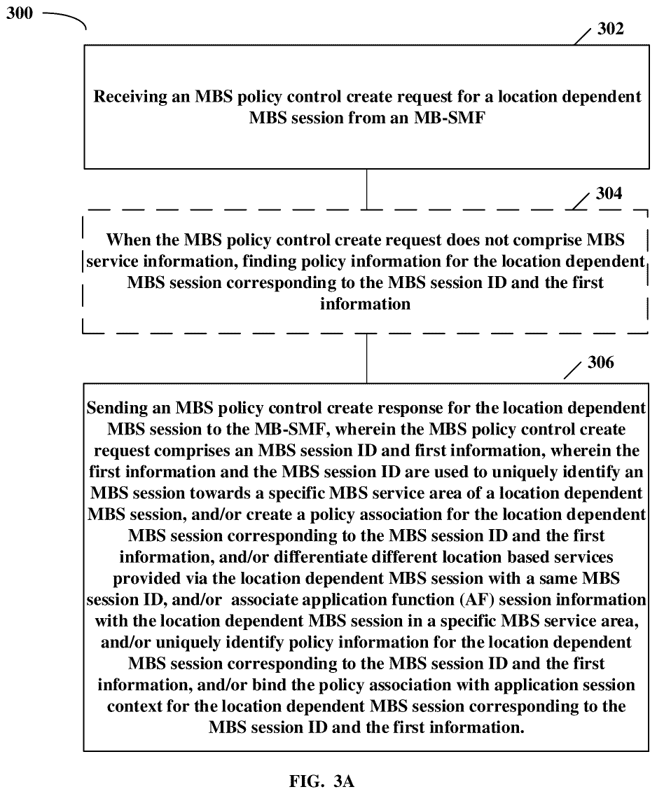

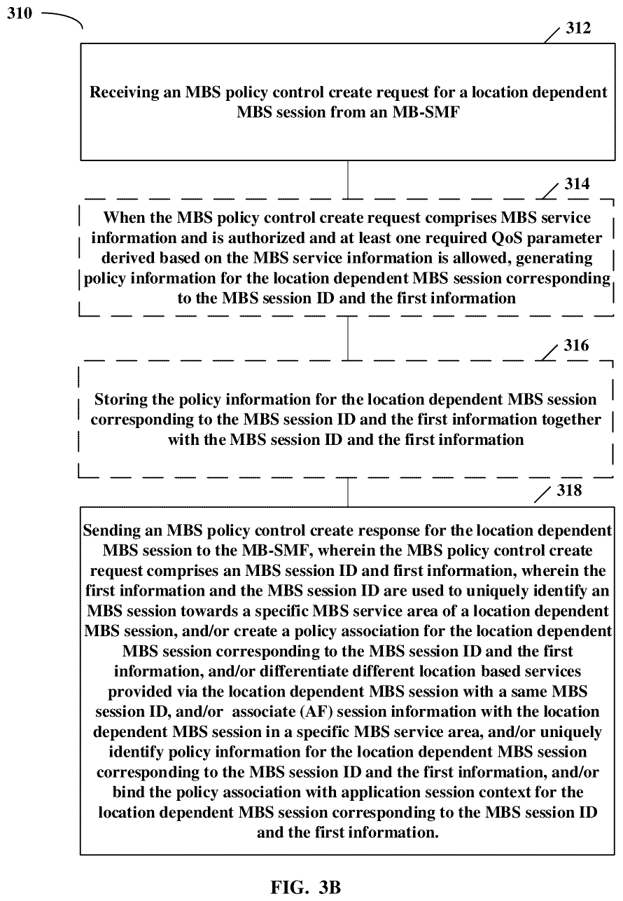

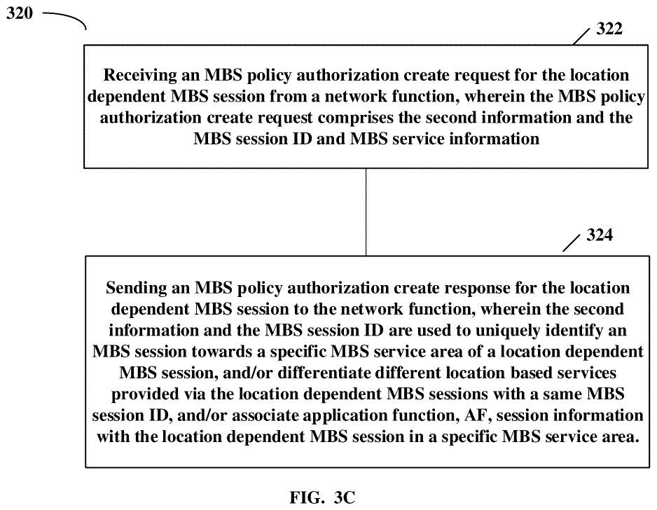

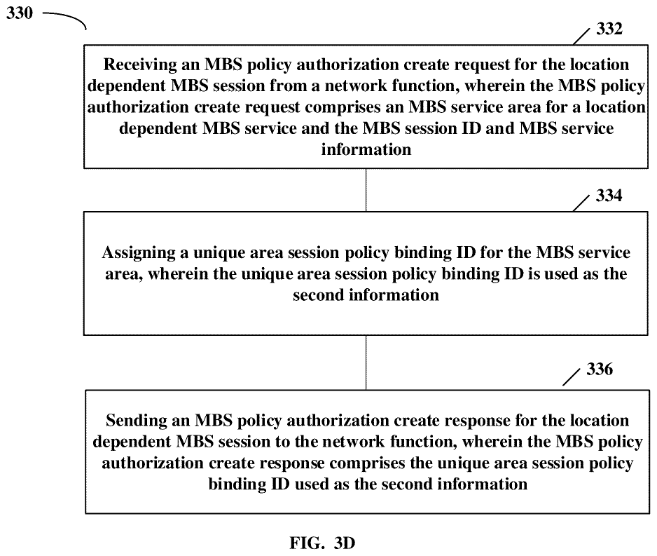

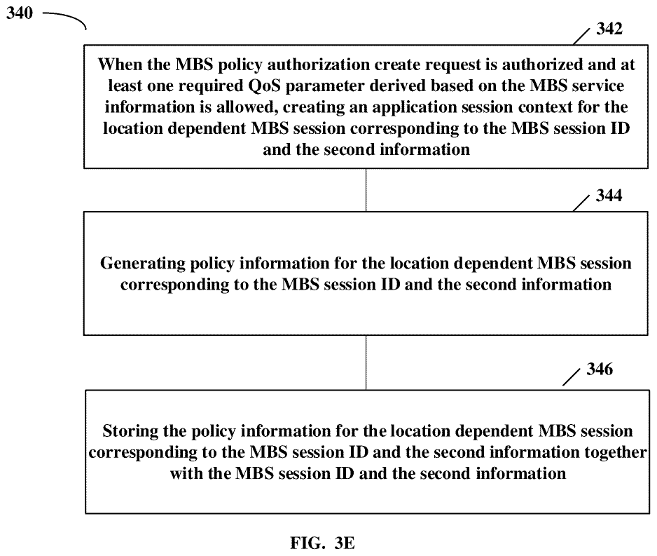

FIG. 3A shows a flowchart of a method according to another embodiment of the present disclosure, which may be performed by an apparatus implemented in/as or communicatively coupled to a PCF. As such, the apparatus may provide means for accomplishing various parts of the method 300 as well as means for accomplishing other processes in conjunction with other components. For some parts which have been described in the above embodiments, the description thereof is omitted here for brevity.

At block 302, the PCF may receive an MBS policy control create request for a location dependent MBS session from an MB-SMF.

In an embodiment, the MBS policy control create request may comprise an MBS session ID and first information.

In an embodiment, the first information may comprise at least one of an ID, or an MBS service area.

In an embodiment, the ID may comprise at least one of a binding ID, or an area session policy ID.

In an embodiment, the binding ID may be assigned by at least one of an AF, a network exposure function (NEF), or a multicast/broadcast service function (MBSF).

In an embodiment, the area session policy ID may comprise at least one of an area session ID, or an area session policy binding ID.

In an embodiment, the area session policy binding ID may be assigned by at least one of an AF, an NEF, an MBSF or the PCF.

In an embodiment, if an MBS policy authorization create request for the location dependent MBS session has not been sent to the PCF, the area session ID may be used as the area session policy ID.

In an embodiment, if the MBS policy authorization create request for the location dependent MBS session has been sent to the PCF, the area session policy binding ID may be used as the area session policy ID.

In an embodiment, the first information and the MBS session ID may be used to uniquely identify an MBS session towards a specific MBS service area of a location dependent MBS session, and/or create a policy association for the location dependent MBS session corresponding to the MBS session ID and the first information, and/or differentiate different location based services provided via the location dependent MBS session with a same MBS session ID, and/or associate application function (AF) session information with the location dependent MBS session in a specific MBS service area, and/or uniquely identify policy information for the location dependent MBS session corresponding to the MBS session ID and the first information, and/or bind the policy association with application session context for the location dependent MBS session corresponding to the MBS session ID and the first information.

For example, the MB-SMF may send the MBS policy control create request at block 202 of FIG. 2A, and then the PCF may receive the MBS policy control create request from the MB-SMF.

At block 304, optionally, when the MBS policy control create request does not comprise MBS service information, the PCF may find policy information for the location dependent MBS session corresponding to the MBS session ID and the first information.

For example, if the optional interaction between the network function such as AF/NEF/MBSF and the PCF has been performed (e.g., the MBS Service Information was provided to the PCF in Npcf_MBSPolicy_Authorization_Create Request), the MBS policy control create request does not comprise MBS service information. In this case, the PCF may has generated and stored policy information for the location dependent MBS session corresponding to the MBS session ID and the first information. The PCF may find the policy information for the location dependent MBS session corresponding to the MBS session ID and the first information.

At block 306, the PCF may send an MBS policy control create response for the location dependent MBS session to the MB-SMF. For example, the MBS policy control create response may comprise the policy information for the location dependent MBS session corresponding to the MBS session ID and the first information.

FIG. 3B shows a flowchart of a method according to another embodiment of the present disclosure, which may be performed by an apparatus implemented in/as or communicatively coupled to a PCF. As such, the apparatus may provide means for accomplishing various parts of the method 310 as well as means for accomplishing other processes in conjunction with other components. For some parts which have been described in the above embodiments, the description thereof is omitted here for brevity.

At block 312, the PCF may receive an MBS policy control create request for a location dependent MBS session from an MB-SMF. Block 312 is same as block 302 of FIG. 3A.

In an embodiment, when the MBS policy control create request comprises MBS service information and is authorized and at least one required quality of service (QOS) parameter derived based on the MBS service information is allowed, blocks 314 and 316 may be performed.

The MBS service information may be same or similar as/to the MBS Service Information as defined in clause 6.14 of 3GPP TS 23.247 V18.1.0.

For example, if the optional interaction between the network function such as AF/NEF/MBSF and the PCF has not been performed (e.g., the MBS Service Information was not provided to the PCF), the MBS policy control create request may comprise the MBS service information. In this case, the PCF may generate and store policy information for the location dependent MBS session corresponding to the MBS session ID and the first information.

At block 314, the PCF may generate policy information for the location dependent MBS session corresponding to the MBS session ID and the first information. For example, the policy information may be same or similar as/to the policy information as defined in clause 6.10 of 3GPP TS 23.247 V18.1.0.

At block 316, the PCF may store the policy information for the location dependent MBS session corresponding to the MBS session ID and the first information together with the MBS session ID and the first information.

At block 318, the PCF may send an MBS policy control create response for the location dependent MBS session to the MB-SMF. Block 318 is same as block 306 of FIG. 3A.

FIG. 3C shows a flowchart of a method according to another embodiment of the present disclosure, which may be performed by an apparatus implemented in/as or communicatively coupled to a PCF. As such, the apparatus may provide means for accomplishing various parts of the method 320 as well as means for accomplishing other processes in conjunction with other components. For some parts which have been described in the above embodiments, the description thereof is omitted here for brevity.

At block 322, the PCF may receive an MBS policy authorization create request for the location dependent MBS session from a network function.

In an embodiment, the MBS policy authorization create request may comprise the second information and the MBS session ID and MBS service information.

In an embodiment, the network function may comprise at least one of an AF, an NEF, or an MBSF.

The MBS policy authorization create request may be an existing message or a new message. In an embodiment, the MBS policy authorization create request may be an Npcf_MBSPolicy_Authorization_Create Request for example as described in 3GPP TS 23.247 V18.1.0.

The second information may be of any suitable form and the present disclosure has no limit on it. For example, the second information may be an identifier, an MBS service area, etc.

The second information may be obtained in various ways and the present disclosure has no limit on it. For example, the second information may be assigned/allocated by at least one of an AF, a network exposure function (NEF), a multicast/broadcast service function (MBSF).

In an embodiment, the second information and the MBS session ID may be used to uniquely identify an MBS session towards a specific MBS service area of a location dependent MBS session, and/or differentiate different location based services provided via the location dependent MBS sessions with a same MBS session ID, and/or associate application function (AF) session information with the location dependent MBS session in a specific MBS service area.

In an embodiment, the second information may comprise at least one of a binding ID, an area session policy binding ID, or an MBS service area.

In an embodiment, the binding ID may be assigned by at least one of an AF, an NEF, or a MBSF.

In an embodiment, the area session policy binding ID may be assigned by at least one of the AF, the NEF, or the MBSF.

At block 324, the PCF may send an MBS policy authorization create response for the location dependent MBS session to the network function.

The MBS policy authorization create response may be an existing message or a new message. In an embodiment, the MBS policy authorization create response may be an Npcf_MBSPolicy_Authorization_Create Response for example as described in V18.1.0.

FIG. 3D shows a flowchart of a method according to another embodiment of the present disclosure, which may be performed by an apparatus implemented in/as or communicatively coupled to a PCF. As such, the apparatus may provide means for accomplishing various parts of the method 330 as well as means for accomplishing other processes in conjunction with other components. For some parts which have been described in the above embodiments, the description thereof is omitted here for brevity.

At block 332, the PCF may receive an MBS policy authorization create request for the location dependent MBS session from a network function. The MBS policy authorization create request may comprise an MBS service area for a location dependent MBS service and the MBS session ID and MBS service information.

At block 334, the PCF may assign a unique area session policy binding ID for the MBS service area.

In an embodiment, the unique area session policy binding ID may be used as the second information.

For example, the PCF may assign a unique area session policy binding ID for the MBS service area based on the MBS service area in the MBS policy authorization create request.

At block 336, the PCF may send an MBS policy authorization create response for the location dependent MBS session to the network function.

In an embodiment, the MBS policy authorization create response may comprise the unique area session policy binding ID used as the second information.

FIG. 3E shows a flowchart of a method according to another embodiment of the present disclosure, which may be performed by an apparatus implemented in/as or communicatively coupled to a PCF. As such, the apparatus may provide means for accomplishing various parts of the method 340 as well as means for accomplishing other processes in conjunction with other components. For some parts which have been described in the above embodiments, the description thereof is omitted here for brevity.

In an embodiment, when the MBS policy authorization create request is authorized and at least one required QoS parameter derived based on the MBS service information is allowed, blocks 342, 344 and 346 may be performed.

At block 342, the PCF may create an application session context for the location dependent MBS session corresponding to the MBS session ID and the second information.

The application session context may be same or similar as/to the application session context as described in 3GPP TS 23.247 V18.1.0.

At block 344, the PCF may generate policy information for the location dependent MBS session corresponding to the MBS session ID and the second information. For example, the policy information may be same or similar as/to the policy information as defined in clause 6.10 of 3GPP TS 23.247 V18.1.0.

At block 346, the PCF may store the policy information for the location dependent MBS session corresponding to the MBS session ID and the second information together with the MBS session ID and the second information.

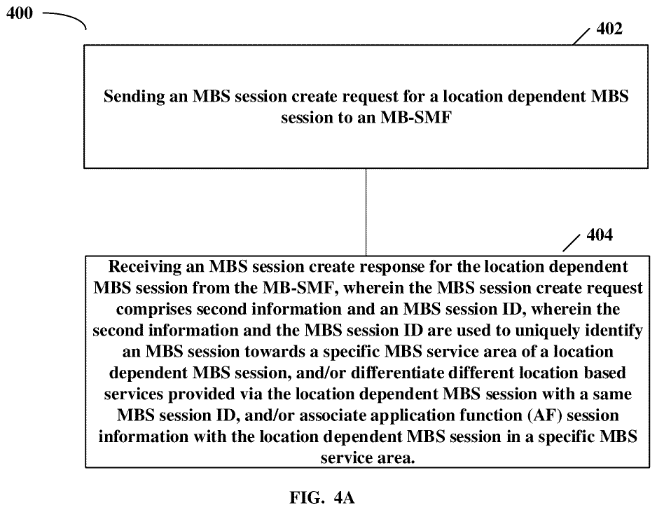

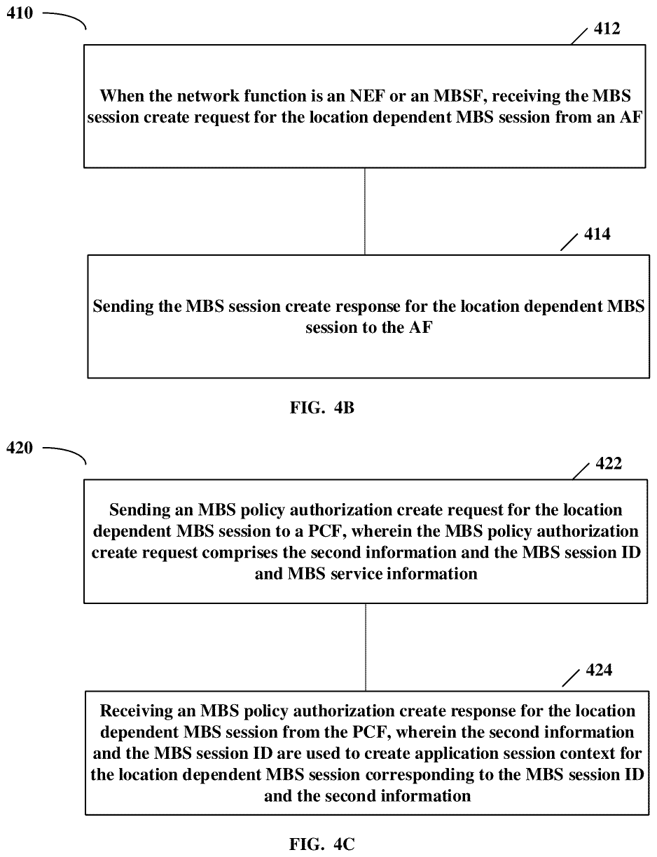

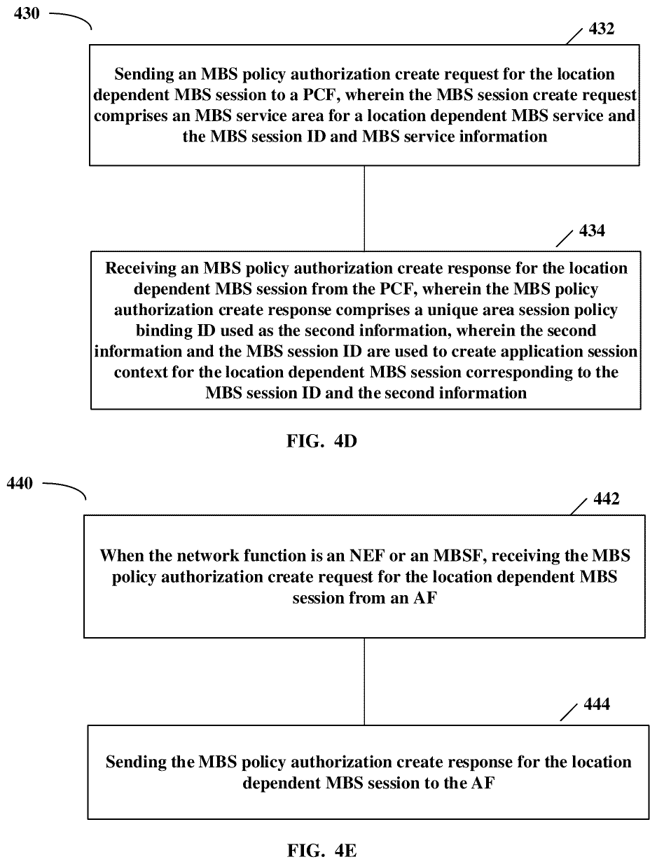

FIG. 4A shows a flowchart of a method according to another embodiment of the present disclosure, which may be performed by an apparatus implemented in/as or communicatively coupled to a network function. As such, the apparatus may provide means for accomplishing various parts of the method 400 as well as means for accomplishing other processes in conjunction with other components. For some parts which have been described in the above embodiments, the description thereof is omitted here for brevity.

At block 402, the network function may send an MBS session create request for a location dependent MBS session to an MB-SMF.

At block 404, the network function may receive an MBS session create response for the location dependent MBS session from the MB-SMF.

In an embodiment, when the network function is an AF, the network function may send the MBS session create request for the location dependent MBS session to the MB-SMF directly. The network function may receive the MBS session create response for the location dependent MBS session from the MB-SMF directly.

In an embodiment, when the network function is an AF, the network function may send the MBS session create request for the location dependent MBS session to the MB-SMF via an NEF or an MBSF. The network function may receive the MBS session create response for the location dependent MBS session from the MB-SMF via the NEF or the MBSF.

In an embodiment, the MBS session create request may comprise second information and an MBS session ID.

In an embodiment, the second information and the MBS session ID may be used to uniquely identify an MBS session towards a specific MBS service area of a location dependent MBS session, and/or differentiate different location based services provided via the location dependent MBS session with a same MBS session ID, and/or associate application function (AF) session information with the location dependent MBS session in a specific MBS service area.

In an embodiment, the second information may comprise at least one of a binding ID, an area session policy binding ID, or an MBS service area.

In an embodiment, the binding ID may be assigned by at least one of an AF, an NEF, or an MBSF.

In an embodiment, the area session policy binding ID may be assigned by at least one of the AF, the NEF, or the MBSF.

In an embodiment, the MBS session create response may comprise an area session ID and the second information.

In an embodiment, the network function may comprise at least one of an AF, an NEF, or an MBSF.

FIG. 4B shows a flowchart of a method according to another embodiment of the present disclosure, which may be performed by an apparatus implemented in/as or communicatively coupled to a network function. As such, the apparatus may provide means for accomplishing various parts of the method 410 as well as means for accomplishing other processes in conjunction with other components. For some parts which have been described in the above embodiments, the description thereof is omitted here for brevity.

In an embodiment, the network function may be an NEF or an MBSF.

At block 412, the network function may receive the MBS session create request for the location dependent MBS session from an AF. For example, after receiving the MBS session create request at block 412, the network function may send the MBS session create request for the location dependent MBS session to the MB-SMF at block 402 of FIG. 4A.

At block 414, the network function may send the MBS session create response for the location dependent MBS session to the AF. For example, the network function may receive the MBS session create response from the MB-SMF at block 404 of FIG. 4A. Then the network function may send the MBS session create response to the AF at block 414 of FIG. 4A.

FIG. 4C shows a flowchart of a method according to another embodiment of the present disclosure, which may be performed by an apparatus implemented in/as or communicatively coupled to a network function. As such, the apparatus may provide means for accomplishing various parts of the method 420 as well as means for accomplishing other processes in conjunction with other components. For some parts which have been described in the above embodiments, the description thereof is omitted here for brevity.

At block 422, the network function may send an MBS policy authorization create request for the location dependent MBS session to a PCF. In an embodiment, the MBS policy authorization create request may comprise the second information and the MBS session ID and MBS service information.

In an embodiment, when the network function may optionally, e.g. based on local configuration, decide to interact with the PCF, the network function may send the MBS policy authorization create request for the location dependent MBS session to the PCF at block 422.

At block 424, the network function may receive an MBS policy authorization create response for the location dependent MBS session from the PCF.

In an embodiment, the network function may the second information and the MBS session ID may be used to create application session context for the location dependent MBS session corresponding to the MBS session ID and the second information.

FIG. 4D shows a flowchart of a method according to another embodiment of the present disclosure, which may be performed by an apparatus implemented in/as or communicatively coupled to a network function. As such, the apparatus may provide means for accomplishing various parts of the method 430 as well as means for accomplishing other processes in conjunction with other components. For some parts which have been described in the above embodiments, the description thereof is omitted here for brevity.

At block 432, the network function may send an MBS policy authorization create request for the location dependent MBS session to a PCF. In an embodiment, the MBS session create request may comprise an MBS service area for a location dependent MBS service and the MBS session ID and MBS service information.

At block 434, the network function may receive an MBS policy authorization create response for the location dependent MBS session from the PCF. In an embodiment, the MBS policy authorization create response may comprise a unique area session policy binding ID used as the second information.

In an embodiment, the second information and the MBS session ID may be used to create application session context for the location dependent MBS session corresponding to the MBS session ID and the second information.

In an embodiment, when the network function is an AF, the network function may send the MBS policy authorization create request for the location dependent MBS session to the PCF directly. The network function may receive an MBS policy authorization create response for the location dependent MBS session from the PCF directly.

In an embodiment, when the network function is an AF, the network function may send the MBS policy authorization create request for the location dependent MBS session to the PCF via an NEF or an MBSF. The network function may receive an MBS policy authorization create response for the location dependent MBS session from the PCF via the NEF or the MBSF.

FIG. 4E shows a flowchart of a method according to another embodiment of the present disclosure, which may be performed by an apparatus implemented in/as or communicatively coupled to a network function. As such, the apparatus may provide means for accomplishing various parts of the method 440 as well as means for accomplishing other processes in conjunction with other components. For some parts which have been described in the above embodiments, the description thereof is omitted here for brevity.

In an embodiment, the network function may be an NEF or an MBSF.

At block 442, the network function may receive the MBS policy authorization create request for the location dependent MBS session from an AF. For example, after receiving the MBS policy authorization create request, the network function may send the MBS policy authorization create request to the PCF at block 432 of FIG. 4D.

At block 444, the network function may send the MBS policy authorization create response for the location dependent MBS session to the AF. For example, the network function may receive the MBS policy authorization create response from the PCF at block 434 of FIG. 4D. Then the network function may send the MBS policy authorization create response to the AF.

In an embodiment, it may propose three alternatives to address the problems. For example, it may introduce area session policy binding ID together with area session policy ID. It may introduce MBS service area. It may use an identifier that uniquely identifies a session towards a specific MBS service area within the same MBS session ID. It may not care the format or meaning of the identifier since the identifier is used as a binder of sessions. For example, it can use “binding ID”.

Alternative 1: area session policy binding ID together with area session policy ID.

In an embodiment, an area session policy binding ID can be assigned by AF/NEF/MBSF or by PCF, which may be used to uniquely identify an MBS session towards a specific MBS service area with the same MBS session ID.

In an embodiment, the area session policy ID may be a new attribute introduced to the MB-SMF policy control creation procedure for a location dependent MBS service. The MB-SMF can use area session ID or area session policy binding ID as area session policy ID.

Option 1: area session policy binding ID may be assigned by AF/NEF/MBSF.

In an embodiment, when AF/NEF/MBSF does not interact with the PCF, the MB-SMF may use area session ID as area session policy ID.

In an embodiment, when the AF/NEF/MBSF decides to interact with the PCF for example based on local configuration, the AF/NEF/MBSF may assign a new area session policy binding ID and sends it to PCF.

In an embodiment, the AF/NEF/MBSF may also include area session policy binding ID in Nmbsmf_MBSSession_Create request sent to MB-SMF.

In an embodiment, the MB-SMF may use area session policy binding ID as area session policy ID and send it to the PCF so that the PCF can retrieve the policy authorized previously when AF/NEF/MBSF interacted with PCF.

In an embodiment, the MB-SMF may include the area session policy binding ID in Nmbsmf MBSSession_Create response.

FIG. 5 shows a flowchart of MBS session creation with PCC according to another embodiment of the present disclosure.

Steps 1 to 7 are optional and only applicable if TMGI is used as MBS session ID and required to be pre-allocated.

Steps 1 to 9: Same as in FIG. 7.1.1.2-1 of 3GPP TS 23.247 V18.1.0.

Clause 7.1.1.2 of 3GPP TS 23.247 V18.1.0 describes steps 1 to 9 as below.

1. AF sends Nnef_MBSTMGI_Allocate Request (TMGI number, [MBS service area]) message to NEF/MBSF to request allocation of a TMGI(s) to identify new MBS session(s). The MBS service area indicates the possible service area for those TMGI(s) to be allocated, which may be needed for local MBS.

NOTE 1: Depending on the network deployment and use case, MB-SMF may receive requests from AF directly, or via NEF, or via MBSF, or via NEF and MBSF.

2. NEF/MBSF checks authorization of AF. If geographical area information or civic address information was provided by the AF as MBS service area, NEF/MBSF performs the translation.

NOTE 2: NEF is not required if AF is in trusted domain.

3. NEF/MBSF discovers and selects an MB-SMF using NRF or based on local configuration, possibly based on MBS service area.

4. NEF/MBSF sends an Nmbsmf_TMGI_Allocate Request (TMGI number) message to the MB-SMF.

5. MB-SMF allocates TMGI(s) and returns the TMGI(s) to the NEF/MBSF via the Nmbsmf_TMGI_Allocate response (TMGI(s), expiration time).

6. The NEF or MBSF responds to the AF by sending an Nnef_MBSTMGI_Allocate Response (TMGI(s), expiration time).

7. The AF may perform a Service Announcement towards UEs. The AF informs UEs about MBS session information with MBS session ID, e.g. TMGI, SSM, and possibly other information e.g. MBS service area, session description information, etc.

The MBS service area information can be Cell ID list, TAI list, geographical area information or civic address information. Amongst them, Cell ID list and TAI list shall only be used by AFs who reside in trust domain, and when the AFs are aware of such information.

The UE needs to be aware if the service is broadcast or multicast to decide if JOIN is to be performed.

8. AF of content provider may provide description for an MBS session (possibly providing information for a previously allocated TMGI to NEF via a Nnef_MBSSession_Create request ([MBS session ID], MBS service type, MBS Service Information, [TMGI allocation request], [MBS service area], [Any UE indication], [start and end time of the MBS session], [MBS session state], [ingress transport address request indication], [Request for location-dependent session], [FSA ID(s)]). If step 1-6 has not been executed before, the AF may provide an MBS session ID containing an SSM or it may request that the network allocates an MBS session ID (i.e., TMGI). The AF provides the MBS service type (i.e. either multicast service or broadcast service) and MBS Service Information (as defined in clause 6.14 of 3GPP TS 23.247 V18.1.0). The AF may provide the “Any UE indication” (indicating whether a multicast MBS session is “open to any UEs”), MBS service area, start and end time of the MBS session and MBS session state (active/inactive). In addition, the AF request may also indicate that the allocation of an ingress transport address is requested and that the AF request is for a location dependent MBS service.

If geographical area information or civic address information was provided by the AF as MBS service area, NEF/MBSF translates the MBS service area to Cell ID list or TAI list.

For broadcast communication, the AF may determine MBS FSA ID(s) for the Broadcast MBS session based on business agreements and include them in the description of the MBS session.

NOTE 3: MBS session state is applicable for multicast MBS session.

9. NEF/MBSF checks authorization of content provider.

10. The NEF/MBSF may optionally, based on local configuration, decide to interact with the PCF.

NOTE 1: In the deployment without NEF and MBSF, the AF optionally interacts with PCF in steps 11-18.

If the NEF/MBSF decided to interact with the PCF, steps 11 to 19 are performed, and in step 20 the MBS Service Information is not provided to the MB-SMF.

If the NEF/MBSF decided not to interact with the PCF, steps 12 to 19 are skipped, and in step 20 the MBS Service Information is provided to the MB-SMF.

11. [Conditional] If the NEF/MBSF did not receive an MBS session ID from the AF in step 8, the NEF/MBSF sends an Nmbsmf_TMGI_Allocate Request message to the MB-SMF and the MB-SMF allocates a TMGI and returns the TMGI to the NEF/MBSF via the Nmbsmf_TMGI_Allocate response (TMGI, expiration time).

12. [Conditional] If the NEF/MBSF receives the Request for location-dependent session from the AF and if there is a need to select the same PCF for the location dependent MBS sessions, the NEF/MBSF first uses the BSF Discovery service to discover whether there is a PCF serving the MBS session with the MBS session ID by using Nbsf_management_Discovery operation. If there is a PCF registered for the MBS session ID, the NEF/MBSF interacts with that PCF and skips the following step 13.

NOTE 2: This step is not necessary in a deployment with a single PCF.

13. [Conditional] If step 12 was not executed or the interaction with the BSF revealed that no PCF is registered for the MBS session ID, the NEF/MBSF discovers the PCF candidates by interacting with the NRF and selects a PCF, possibly based on MBS service area.

14. The NEF/MBSF sends an Npcf_MBSPolicy_Authorization_Create Request (MBS session ID, [area session policy binding ID], MBS Service Information (as defined in clause 6.14 of 3GPP TS 23.247 V18.1.0)) to the PCF.

Area session policy binding ID may be assigned by NEF/MBSF for location dependent MBS service.

NOTE X: In the deployment without NEF and MBSF, it is the AF that assigns the area session policy binding ID for location dependent MBS service.

15. [Optional] The PCF may retrieve authorization information for the MBS session from the UDR (see clause 6.10.2 of 3GPP TS 23.247 V18.1.0) and takes it into account for the subsequent authorization and QoS allowance check.

NOTE 3: This step is not necessary in a deployment with a single PCF if authorization data are stored in the PCF.

16. The PCF determines whether the request is authorized and if the request is authorized, the PCF derives the required QoS parameters based on the received MBS Service Information and determines whether this QoS is allowed. If the required QoS is allowed, the PCF generates the policy information for the MBS session (as defined in clause 6.10 of 3GPP TS 23.247 V18.1.0) and stores it together with the MBS session ID and the area session policy binding ID.

17. If the request is authorized and the required QoS is allowed, the PCF registers at the BSF that it handles the MBS session by using Nbsf_management_Register Request (MBS session ID, PCF ID). It provides an identifier that the policy association is for MBS and the MBS session ID, its own PCF ID and optionally its PCF set ID.

NOTE 4: This step is not necessary in a deployment with a single PCF.

18. The PCF sends an Npcf_MBSPolicy_Authorization_Create Response (Result indication) to the NEF/MBSF.

If the request is not authorized or the required QoS is not allowed, the PCF indicates so in the response to the NEF/MBSF which in turn informs the AF about it (by sending the Nnef_MBSSession_Create response) and ends this procedure.

19. Same as step 10 in FIG. 7.1.1.2-1 of 3GPP TS 23.247 V18.1.0 as below.

NEF/MBSF discovers MB-SMF candidates and selects MB-SMF as ingress control node, possibly based on MBS service area. If a TMGI is included in step 8, NEF/MBSF finds MB-SMF based on that TMGI.

20. Same as step 11 in FIG. 7.1.1.2-1 of 3GPP TS 23.247 V18.1.0 with the following differences:
the MBS Service Information is not present if the optional interaction between AF/NEF/MBSF and PCF has been performed (as the MBS Service Information was provided to the PCF in step 14).
for location dependent MBS service, area session policy binding ID is sent by AF/NEF/MBSF to MB-SMF in Nmbsmf_MBSSession_Create Request.

Step 11 in FIG. 7.1.1.2-1 of 3GPP TS 23.247 V18.1.0 is as below.

NEF/MBSF sends Nmbsmf_MBSSession_Create Request ([MBS session ID], MBS service type, [TMGI allocation request], MBS Service Information (as defined in clause 6.14), [MBS service area], [Any UE indication], [start and end time of the MBS session], [MBS session state], [ingress transport address request indication], [FSA ID(s)], [multicast session security context]) to MB-SMF, to request MB-SMF to reserve ingress resources for a MBS distribution session. The NEF/MBSF forwards all parameters it has received from the AF in step 8. If the MBSF decides to insert an MBSTF into the user plane for the MBS session, it also indicates that the allocation of an ingress transport address is requested even if this was not requested in step 8. The request also includes the Any UE indication if provided in step 8. If the MBSF acts as the MBS security function for multicast as defined in TS 33.501 [20], it provides a multicast session security context for the MBS session.

If requested to do so, or if a source specific multicast is provided as MBS session ID in step 11, the MB-SMF allocates a TMGI.

For broadcast communication, if no MBS FSA ID(s) have been received, the MB-SMF selects MBS FSA ID(s) for the Broadcast MBS session based on local configuration.

21. The MB-SMF discovers the PCF using NRF.

22. The MB-SMF sends an Npcf_MBSPolicyControl_Create Request (MBS session ID, [area session policy ID], [MBS Service Information (as defined in clause 6.14)]) for the MBS session towards the PCF. The MB-SMF forwards the MBS Service Information to the PCF if received from the NEF/MBSF in the previous step 20.

For location dependent MBS service, the MB-SMF also sends area session policy ID to the PCF as follows:
If the AF/NEF/MBSF has not interacted with PCF, the MB-SMF use area session ID as area session policy ID.
If AF/NEF/MBSF has interacted with PCF, the MB-SMF uses area session policy binding ID (received from AF/NEF/MBSF) as area session policy ID.

If PCF receives MBS Service Information from the MB-SMF, the PCF performs the subsequent steps 23 to 26. If the PCF does not receive MBS Service Information from the MB-SMF, but has previously determined policy information for the MBS session (see step 16) corresponding to the MBS session ID (and area session policy ID for location dependent MBS) received from the MB-SMF, the PCF continues with step 27.

23. If the PCF is not handling the MBS session ID, the PCF uses the BSF Register service to check whether there is already a PCF serving the MBS session. If so, the PCF skips steps 24 to 26 and indicates in step 27 that the PCF serving the MBS session shall be contacted.

NOTE 5: This step is not necessary in a deployment with a single PCF.

24. [Optional] The PCF may retrieve authorization information for the MBS session from the UDR (see clause 6.10.2 of 3GPP TS 23.247 V18.1.0) and takes it into account for the subsequent authorization and QoS allowance check.

NOTE 6: This step is not necessary if authorization data are stored in the PCF.

25. The PCF determines whether the request is authorized and if the request is authorized, the PCF derives the required QoS parameters based on the received MBS Service Information and determines whether this QoS is allowed. If the required QoS is allowed, the PCF generates the policy information for the MBS session (as defined in clause 6.10) and stores it together with the MBS session ID.

26. If the request is authorized and the required QoS is allowed the PCF registers at the BSF that it handles the MBS session by using Nbsf_management_Register Request (MBS session ID, PCF ID). It provides an identifier that the policy association is for MBS and the MBS session ID, its own PCF ID and optionally its PCF set ID.

NOTE 7: This step is not necessary in a deployment with a single PCF.

27. The PCF responds with Npcf_MBSPolicyControl_Create Response ([policy information for the MBS session (as defined in clause 6.10 of 3GPP TS 23.247 V18.1.0 )], Result indication).

If the request is not authorized or the required QoS is not allowed, the PCF indicates so in the response to the MB-SMF which in turn informs the AF about it (by sending the Nmbsmf_MBSSession_Create response) and ends this procedure.

If another PCF is serving the MBS session, the PCF indicates that another PCF serving the MBS session shall be contacted and provides an ID of that other PCF. The MB-SMF then repeats step 22 towards that other PCF.

28-37: Same as steps 14-22 in FIG. 7.1.1.2-1 of 3GPP TS 23.247 V18.1.0, with the following difference:

In step 30, the MB-SMF includes area session policy binding ID in Nmbsmf MBSSession_Create response if the area session policy binding ID was received in step 20.

NOTE 7a: if AF/NEF/MBSF has the mechanism to associate the area session ID and the area session policy binding ID when receiving Nmbsmf_MBSSession_Create response, there is no need to send back the area session policy binding ID in the response even if the area session policy binding ID was received in step 20.

NOTE 8: Steps 33-36 can be executed in parallel to step 32.

Steps 14-22 in FIG. 7.1.1.2-1 of 3GPP TS 23.247 V18.1.0 are as below.

14. MB-SMF selects the MB-UPF. If the allocation of an ingress transport address was requested in step 11, the MB-SMF requests the MB-UPF to reserve user plane ingress resources. If multicast transport of the MBS data towards RAN nodes is to be used, the MB-SMF also request the MB-UPF to reserve for the outgoing data a tunnel endpoint and the related identifiers (source IP address, SSM and GTP Tunnel ID) and to forward data received at the user plane ingress resource using that tunnel endpoint.

If the allocation of an ingress transport address was not requested in step 11, the MB-SMF provides the SSM received as MBS session ID to the MB-UPF and requests the MB-UPF to join the corresponding multicast tree from the content provider. The MB-SMF may also defer the configuration to join the corresponding multicast tree e.g. based on information that the session is inactive, service requirements and MBS start/end time until receiving the first query for the MBS session as part of the establishment procedure in clause 7.2.1.3, or until receiving a request to activate the MBS session via the MBS session Update procedure in clause 7.1.1.6.

15. If requested, MB-UPF selects an ingress address (IP address and port) and a tunnel endpoint for the outgoing data and provides it to MB-SMF.

16. MB-SMF indicates the possibly allocated ingress address to the NEF/MBSF. MB-SMF may include TMGI if it is allocated in step 11. For broadcast communication, the MB-SMF includes any MBS FSA ID(s) selected in step 11. It also indicates the success or failure of reserving transmission resources.

16a. If a source specific multicast address is provided as MBS session ID in step 11, the MB-SMF updates its NF profile at the NRF with the serving MBS session ID. If an MBS service area was received in step 11, the MB-SMF updates its NF profile at the NRF with that information.

NOTE 3: If TMGI is used to represent an MBS session, MB-SMF does not need to update NRF if the TMGI range(s) supported by an MB-SMF is already included in the MB-SMF profile when MB-SMF register itself into NRF.

17. For broadcast communication, the MB-SMF continues the procedure towards the AMF and NG-RAN as specified in clause 7.3.1 to request the allocation of resources to for the transmission of the broadcast session.

18. [Optional] If the MBSF decides to use an MBSTF, the NEF/MBSF provides the ingress address received in step 16 towards the MBSTF as DL destination. If the allocation of an ingress transport address was requested in step 8, the MBSF requests the MBSTF to allocate the user plane ingress resources. If the allocation of an ingress transport address was not requested in step 8, the MBSF provides the SSM received as Multicast session ID in step 8 and requests the MBSTF to join the corresponding multicast tree from the content provider.

19. [Conditional on step 19] If requested, the MBSTF selects an ingress address (IP address and port) and provides it to NEF/MBSF.

20. The NEF/MBSF-C indicates the possibly allocated ingress address and other parameters (e.g. TMGI) to the AF via an Nnef_MBSSession_Create response ([TMGI], [Allocated ingress address])). If MBS session ID is not provided in step 8, or the MBS session ID is SSM, the NEF/MBSF provides the allocated TMGI. If AF requested the allocation of an ingress transport address, the message also includes the allocated ingress address. For broadcast communication, the message also includes any MBS FSA ID(s) received in step 17.

21. Same as step 7. The AF may also perform a service announcement at this stage.

22. For multicast communication, depending on configuration UEs can join the MBS session as specified in clause 7.2.1.

Option 2: Area session policy binding ID is assigned by PCF.

When AF/NEF/MBSF decides to interact with PCF and the PCF receives the Npcf_MBSPolicyAuthorization_Create from AF/NEF/MBSF:
the PCF may assign a unique area session policy binding ID for this MBS service area. based on the MBS service area in the request,
the PCF may pass the area session policy binding ID through response to AF/NEF/MBSF.

The AF/NEF/MBSF may invoke Nmbsmf_MBSSession_Create using the area session policy binding ID as the area session policy ID.

The MB-SMF may send the area session policy ID to the PCF so that the PCF can retrieve the policy authorized previously when AF/NEF/MBSF interacted with PCF.

The MB-SMF may include area session policy binding ID in Nmbsmf MBSSession_Create response.

FIG. 6 shows a flowchart of MBS session creation with PCC according to another embodiment of the present disclosure.

Steps 1 to 7 are optional and only applicable if TMGI is used as MBS session ID and required to be pre-allocated.

1 to 9: Same as in FIG. 7.1.1.2-1 of 3GPP TS 23.247 V18.1.0.

10. The NEF/MBSF may optionally, based on local configuration, decide to interact with the PCF.

NOTE 1: In the deployment without NEF and MBSF, the AF optionally interacts with PCF in steps 11-18.

If the NEF/MBSF decided to interact with the PCF, steps 11 to 19 are performed, and in step 20 the MBS Service Information is not provided to the MB-SMF.

If the NEF/MBSF decided not to interact with the PCF, steps 12 to 19 are skipped, and in step 20 the MBS Service Information is provided to the MB-SMF.

11. [Conditional] If the NEF/MBSF did not receive an MBS session ID from the AF in step 8, the NEF/MBSF sends an Nmbsmf_TMGI_Allocate Request message to the MB-SMF and the MB-SMF allocates a TMGI and returns the TMGI to the NEF/MBSF via the Nmbsmf TMGI Allocate response (TMGI, expiration time).

12. [Conditional] If the NEF/MBSF receives the Request for location-dependent session from the AF and if there is a need to select the same PCF for the location dependent MBS sessions, the NEF/MBSF first uses the BSF Discovery service to discover whether there is a PCF serving the MBS session with the MBS session ID by using Nbsf_management_Discovery operation. If there is a PCF registered for the MBS session ID, the NEF/MBSF interacts with that PCF and skips the following step 13.

NOTE 2: This step is not necessary in a deployment with a single PCF.

13. [Conditional] If step 12 was not executed or the interaction with the BSF revealed that no PCF is registered for the MBS session ID, the NEF/MBSF discovers the PCF candidates by interacting with the NRF and selects a PCF, possibly based on MBS service area.

14. The NEF/MBSF sends an Npcf_MBSPolicy_Authorization_Create Request (MBS session ID, MBS Service Information (as defined in clause 6.14 of 3GPP TS 23.247 V18.1.0), [MBS Service Area for a location dependent MBS service]) to the PCF.

15. [Optional] The PCF may retrieve authorization information for the MBS session from the UDR (see clause 6.10.2 of 3GPP TS 23.247 V18.1.0) and takes it into account for the subsequent authorization and QoS allowance check.

NOTE 3: This step is not necessary in a deployment with a single PCF if authorization data are stored in the PCF.

16. The PCF determines whether the request is authorized and if the request is authorized, the PCF derives the required QoS parameters based on the received MBS Service Information and determines whether this QoS is allowed. If the required QoS is allowed, the PCF generates the policy information for the MBS session (as defined in clause 6.10 of 3GPP TS 23.247 V18.1.0) and stores it together with the MBS session ID and area session policy binding ID assigned by PCF below.

17. If the request is authorized and the required QoS is allowed, the PCF registers at the BSF that it handles the MBS session by using Nbsf_management_Register Request (MBS session ID, PCF ID). It provides an identifier that the policy association is for MBS and the MBS session ID, its own PCF ID and optionally its PCF set ID.

NOTE 4: This step is not necessary in a deployment with a single PCF.

18. The PCF may assign area session policy binding ID based on the received MBS session Area for location dependent MBS service and send an Npcf_MBSPolicy_Authorization_Create Response (Result indication, [area session policy binding ID]) to the NEF/MBSF.

Area session policy binding ID may be assigned by PCF for location dependent MBS service.

If the request is not authorized or the required QoS is not allowed, the PCF indicates so in the response to the NEF/MBSF which in turn informs the AF about it (by sending the Nnef MBSSession_Create response) and ends this procedure.

19. Same as step 10 in FIG. 7.1.1.2-1 of 3GPP TS 23.247 V18.1.0.

20. Same as step 11 in FIG. 7.1.1.2-1 of 3GPP TS 23.247 V18.1.0 with the following differences:
the MBS Service Information is not present if the optional interaction between AF/NEF/MBSF and PCF has been performed (as the MBS Service Information was provided to the PCF in step 14).
for location dependent MBS service and the AF/NEF/MBSF has interacted with PCF, area session policy binding ID are sent by NEF/MBSF to MB-SMF. Otherwise, no area session policy binding ID is given.

21. The MB-SMF discovers the PCF using NRF.

22. The MB-SMF sends an Npcf_MBSPolicyControl_Create Request (MBS session ID, [area session policy ID], [MBS Service Information (as defined in clause 6.14)]) for the MBS session towards the PCF. The MB-SMF forwards the MBS Service Information to the PCF if received from the NEF/MBSF in the previous step 20.

For location dependent MBS service, the MB-SMF also sends area session policy ID to the PCF as follows:
If the AF/NEF/MBSF has not interacted with PCF, the MB-SMF use area session ID as area session policy ID.
If AF/NEF/MBSF has interacted with PCF, the MB-SMF use area session policy binding ID (received from AF/NEF/MBSF) as area session policy ID.

If PCF receives MBS Service Information from the MB-SMF, the PCF performs the subsequent steps 23 to 26. If the PCF does not receive MBS Service Information from the MB-SMF, but has previously determined policy information for the MBS session (see step 16) corresponding to the MBS session ID (and area session policy ID for location dependent MBS) received from the MB-SMF, the PCF continues with step 27.

23. If the PCF is not handling the MBS session ID, the PCF uses the BSF Register service to check whether there is already a PCF serving the MBS session. If so, the PCF skips steps 24 to 26 and indicates in step 27 that the PCF serving the MBS session shall be contacted.

NOTE 5: This step is not necessary in a deployment with a single PCF.

24. [Optional] The PCF may retrieve authorization information for the MBS session from the UDR (see clause 6.10.2 of 3GPP TS 23.247 V18.1.0) and takes it into account for the subsequent authorization and QoS allowance check.

NOTE 6: This step is not necessary if authorization data are stored in the PCF.

25. The PCF determines whether the request is authorized and if the request is authorized, the PCF derives the required QoS parameters based on the received MBS Service Information and determines whether this QoS is allowed. If the required QoS is allowed, the PCF generates the policy information for the MBS session (as defined in clause 6.10 of 3GPP TS 23.247 V18.1.0) and stores it together with the MBS session ID.

26. If the request is authorized and the required QoS is allowed the PCF registers at the BSF that it handles the MBS session by using Nbsf_management_Register Request (MBS session ID, PCF ID). It provides an identifier that the policy association is for MBS and the MBS session ID, its own PCF ID and optionally its PCF set ID.

NOTE 7: This step is not necessary in a deployment with a single PCF.

27. The PCF responds with Npcf_MBSPolicyControl_Create Response ([policy information for the MBS session (as defined in clause 6.10 of 3GPP TS 23.247 V18.1.0 )], Result indication).

If the request is not authorized or the required QoS is not allowed, the PCF indicates so in the response to the MB-SMF which in turn informs the AF about it (by sending the Nmbsmf MBSSession_Create response) and ends this procedure.

If another PCF is serving the MBS session, the PCF indicates that another PCF serving the MBS session shall be contacted and provides an ID of that other PCF. The MB-SMF then repeats step 22 towards that other PCF.

28-37: Same as steps 14-22 in FIG. 7.1.1.2-1 of 3GPP TS 23.247 V18.1.0, with the following difference:

In step 30, the MB-SMF includes area session policy binding ID in Nmbsmf MBSSession_Create response if the area session policy binding ID was received in step 20.

NOTE 7a: if AF/NEF/MBSF has the mechanism to associate the area session ID and the area session policy binding ID when receiving Nmbsmf_MBSSession_Create response, there is no need to send back the area session policy binding ID in the response even if the area session policy binding ID was received in step 20.

NOTE 8: Steps 33-36 can be executed in parallel to step 32.

Alternative 2: MBS Service Area

For a location dependent service, the AF can send the MBS Service Area towards NEF/MBSF, together with MBS session ID, this information is a unique identifier to be able to differentiate the location based services with the same MBS session ID. This information can be directly used by Npcf_MBSPolicyAuthrization_Create request and Npcf_MBSPolicyControl_Create Request to avoid the failure cases as described above.

FIG. 7A shows a flowchart of MBS session creation with PCC according to another embodiment of the present disclosure.

Steps 1 to 7 are optional and only applicable if TMGI is used as MBS session ID and required to be pre-allocated.

1 to 9: Same as in FIG. 7.1.1.2-1 of 3GPP TS 23.247 V18.1.0.

10. The NEF/MBSF may optionally, based on local configuration, decide to interact with the PCF.

NOTE 1: In the deployment without NEF and MBSF, the AF optionally interacts with PCF in steps 11-18.

If the NEF/MBSF decided to interact with the PCF, steps 11 to 19 are performed, and in step 20 the MBS Service Information is not provided to the MB-SMF.

If the NEF/MBSF decided not to interact with the PCF, steps 12 to 19 are skipped, and in step 20 the MBS Service Information is provided to the MB-SMF.

11. [Conditional] If the NEF/MBSF did not receive an MBS session ID from the AF in step 8, the NEF/MBSF sends an Nmbsmf_TMGI_Allocate Request message to the MB-SMF and the MB-SMF allocates a TMGI and returns the TMGI to the NEF/MBSF via the Nmbsmf TMGI_Allocate response (TMGI, expiration time).

12. [Conditional] If the NEF/MBSF receives the Request for location-dependent session from the AF and if there is a need to select the same PCF for the location dependent MBS sessions, the NEF/MBSF first uses the BSF Discovery service to discover whether there is a PCF serving the MBS session with the MBS session ID by using Nbsf_management_Discovery operation. If there is a PCF registered for the MBS session ID, the NEF/MBSF interacts with that PCF and skips the following step 13.

NOTE 2: This step is not necessary in a deployment with a single PCF.

13. [Conditional] If step 12 was not executed or the interaction with the BSF revealed that no PCF is registered for the MBS session ID, the NEF/MBSF discovers the PCF candidates by interacting with the NRF and selects a PCF, possibly based on MBS service area.

14. The NEF/MBSF sends an Npcf_MBSPolicy_Authorization_Create Request (MBS session ID, MBS Service Information (as defined in clause 6.14 of 3GPP TS 23.247 V18.1.0), [MBS Service Area for a location dependent MBS service]) to the PCF.

15. [Optional] The PCF may retrieve authorization information for the MBS session from the UDR (see clause 6.10.2 of 3GPP TS 23.247 V18.1.0) and takes it into account for the subsequent authorization and QoS allowance check.

NOTE 3: This step is not necessary in a deployment with a single PCF if authorization data are stored in the PCF.

16. The PCF determines whether the request is authorized and if the request is authorized, the PCF derives the required QoS parameters based on the received MBS Service Information and determines whether this QoS is allowed. If the required QoS is allowed, the PCF generates the policy information for the MBS session (as defined in clause 6.10) and stores it together with the MBS session ID and MBS Service Area.

17. If the request is authorized and the required QoS is allowed, the PCF registers at the BSF that it handles the MBS session by using Nbsf_management_Register Request (MBS session ID, PCF ID). It provides an identifier that the policy association is for MBS and the MBS session ID, its own PCF ID and optionally its PCF set ID.

NOTE 4: This step is not necessary in a deployment with a single PCF.

18. The PCF sends an Npcf_MBSPolicy_Authorization_Create Response (Result indication) to the NEF/MBSF.

If the request is not authorized or the required QoS is not allowed, the PCF indicates so in the response to the NEF/MBSF which in turn informs the AF about it (by sending the Nnef_MBSSession_Create response) and ends this procedure.

19. Same as step 10 in FIG. 7.1.1.2-1 of 3GPP TS 23.247 V18.1.0.

20. Same as step 11 in FIG. 7.1.1.2-1 of 3GPP TS 23.247 V18.1.0 with the following differences:
the MBS Service Information is not present if the optional interaction between AF/NEF/MBSF and PCF has been performed (as the MBS Service Information was provided to the PCF in step 14).
for location dependent MBS service, MBS Service Area shall be included in the Create request.

21. The MB-SMF discovers the PCF using NRF.

22. The MB-SMF sends an Npcf_MBSPolicyControl_Create Request (MBS session ID, [MBS Service Information (as defined in clause 6.14 of 3GPP TS 23.247 V18.1.0)], [MBS Service Area]) for the MBS session towards the PCF. The MB-SMF forwards the MBS Service Information to the PCF if received from the NEF/MBSF in the previous step 20.

For location dependent MBS service, the MB-SMF also sends MBS Service Area to the PCF.

If PCF receives MBS Service Information from the MB-SMF, the PCF performs the subsequent steps 23 to 26. If the PCF does not receive MBS Service Information from the MB-SMF, but has previously determined policy information for the MBS session (see step 16) corresponding to the MBS session ID (and MBS Service Area for a location dependent MBS) received from the MB-SMF, the PCF continues with step 27.

23. If the PCF is not handling the MBS session ID, the PCF uses the BSF Register service to check whether there is already a PCF serving the MBS session. If so, the PCF skips steps 24 to 26 and indicates in step 27 that the PCF serving the MBS session shall be contacted.

NOTE 5: This step is not necessary in a deployment with a single PCF.

24. [Optional] The PCF may retrieve authorization information for the MBS session from the UDR (see clause 6.10.2 of 3GPP TS 23.247 V18.1.0) and takes it into account for the subsequent authorization and QoS allowance check.

NOTE 6: This step is not necessary if authorization data are stored in the PCF.

25. The PCF determines whether the request is authorized and if the request is authorized, the PCF derives the required QoS parameters based on the received MBS Service Information and determines whether this QoS is allowed. If the required QoS is allowed, the PCF generates the policy information for the MBS session (as defined in clause 6.10 of 3GPP TS 23.247 V18.1.0) and stores it together with the MBS session ID.

26. If the request is authorized and the required QoS is allowed the PCF registers at the BSF that it handles the MBS session by using Nbsf_management_Register Request (MBS session ID, PCF ID). It provides an identifier that the policy association is for MBS and the MBS session ID, its own PCF ID and optionally its PCF set ID.

NOTE 7: This step is not necessary in a deployment with a single PCF.

27. The PCF responds with Npcf_MBSPolicyControl_Create Response ([policy information for the MBS session (as defined in clause 6.10 of 3GPP TS 23.247 V18.1.0)], Result indication).

If the request is not authorized or the required QoS is not allowed, the PCF indicates so in the response to the MB-SMF which in turn informs the AF about it (by sending the Nmbsmf_MBSSession_Create response) and ends this procedure.

If another PCF is serving the MBS session, the PCF indicates that another PCF serving the MBS session shall be contacted and provides an ID of that other PCF. The MB-SMF then repeats step 22 towards that other PCF.

28-37: Same as steps 14-22 in FIG. 7.1.1.2-1 of 3GPP TS 23.247 V18.1.0.

NOTE 8: Steps 33-36 can be executed in parallel to step 32.

Alternative 3: Use a unique identifier, binding ID

For each service area of a location dependent MBS service, the AF/NEF/MBSF can tag it with a unique identifier, for example, an AF ID plus a unique string or timestamp plus a unique string. Then the identifier can be further used by Npcf_MBSPolicyAuthorization_Create Request and Npcf_MBSPolicyControl_Create Request to avoid the failure cases we have addressed. For simplicity, we use the term “binding ID” as this unique identifier in the following discussion.

FIG. 7B shows a flowchart of MBS session creation with PCC according to another embodiment of the present disclosure.

Steps 1 to 7 are optional and only applicable if TMGI is used as MBS session ID and required to be pre-allocated.

1 to 9: Same as in FIG. 7.1.1.2-1 of 3GPP TS 23.247 V18.1.0.

9a. For a location dependent MBS service, the NEF/MBSF assigns a binding ID based on the received MBS session ID and MBS Service Area to uniquely identify the session. The binding ID can be a unique string that starts with AF ID or TimeStamp.

10. The NEF/MBSF may optionally, based on local configuration, decide to interact with the PCF.

NOTE 1: In the deployment without NEF and MBSF, the AF optionally interacts with PCF in steps 11-18.

If the NEF/MBSF decided to interact with the PCF, steps 11 to 19 are performed, and in step 20 the MBS Service Information is not provided to the MB-SMF.

If the NEF/MBSF decided not to interact with the PCF, steps 12 to 19 are skipped, and in step 20 the MBS Service Information is provided to the MB-SMF.

11. [Conditional] If the NEF/MBSF did not receive an MBS session ID from the AF in step 8, the NEF/MBSF sends an Nmbsmf_TMGI_Allocate Request (1) message to the MB-SMF and the MB-SMF allocates a TMGI and returns the TMGI to the NEF/MBSF via the Nmbsmf TMGI Allocate response (TMGI, expiration time).

12. [Conditional] If the NEF/MBSF receives the Request for location-dependent session from the AF and if there is a need to select the same PCF for the location dependent MBS sessions, the NEF/MBSF first uses the BSF Discovery service to discover whether there is a PCF serving the MBS session with the MBS session ID by using Nbsf_management_Discovery operation. If there is a PCF registered for the MBS session ID, the NEF/MBSF interacts with that PCF and skips the following step 13.

NOTE 2: This step is not necessary in a deployment with a single PCF.

13. [Conditional] If step 12 was not executed or the interaction with the BSF revealed that no PCF is registered for the MBS session ID, the NEF/MBSF discovers the PCF candidates by interacting with the NRF and selects a PCF, possibly based on MBS service area.

14. The NEF/MBSF sends an Npcf_MBSPolicy_Authorization_Create Request (MBS session ID, MBS Service Information (as defined in clause 6.14 of 3GPP TS 23.247 V18.1.0), [binding ID for a location dependent MBS service]) to the PCF.

15. [Optional] The PCF may retrieve authorization information for the MBS session from the UDR (see clause 6.10.2 of 3GPP TS 23.247 V18.1.0) and takes it into account for the subsequent authorization and QoS allowance check.

NOTE 3: This step is not necessary in a deployment with a single PCF if authorization data are stored in the PCF.

16. The PCF determines whether the request is authorized and if the request is authorized, the PCF derives the required QoS parameters based on the received MBS Service Information and determines whether this QoS is allowed. If the required QoS is allowed, the PCF generates the policy information for the MBS session (as defined in clause 6.10 of 3GPP TS 23.247 V18.1.0) and stores it together with the MBS session ID and the binding ID.

17. If the request is authorized and the required QoS is allowed, the PCF registers at the BSF that it handles the MBS session by using Nbsf_management_Register Request (MBS session ID, PCF ID). It provides an identifier that the policy association is for MBS and the MBS session ID, its own PCF ID and optionally its PCF set ID.

NOTE 4: This step is not necessary in a deployment with a single PCF.

18. The PCF sends an Npcf_MBSPolicy_Authorization_Create Response (Result indication) to the NEF/MBSF.

If the request is not authorized or the required QoS is not allowed, the PCF indicates so in the response to the NEF/MBSF which in turn informs the AF about it (by sending the Nnef MBSSession_Create response) and ends this procedure.

19. Same as step 10 in FIG. 7.1.1.2-1 of 3GPP TS 23.247 V18.1.0.

20. Same as step 11 in FIG. 7.1.1.2-1 of 3GPP TS 23.247 V18.1.0 with the following differences
the MBS Service Information is not present if the optional interaction between AF/NEF/MBSF and PCF has been performed (as the MBS Service Information was provided to the PCF in step 14).
for location dependent MBS service, binding ID shall be included in the Create request.

21. The MB-SMF discovers the PCF using NRF.

22. The MB-SMF sends an Npcf_MBSPolicyControl_Create Request (MBS session ID, [MBS Service Information (as defined in clause 6.14 of 3GPP TS 23.247 V18.1.0)], [binding ID]) for the MBS session towards the PCF. The MB-SMF forwards the MBS Service Information to the PCF if received from the NEF/MBSF in the previous step 20.

For location dependent MBS service, the MB-SMF also sends binding ID to the PCF.

If PCF receives MBS Service Information from the MB-SMF, the PCF performs the subsequent steps 23 to 26. If the PCF does not receive MBS Service Information from the MB-SMF, but has previously determined policy information for the MBS session (see step 16) corresponding to the MBS session ID (and binding ID for location dependent MBS service) received from the MB-SMF, the PCF continues with step 27.

23. If the PCF is not handling the MBS session ID, the PCF uses the BSF Register service to check whether there is already a PCF serving the MBS session. If so, the PCF skips steps 24 to 26 and indicates in step 27 that the PCF serving the MBS session shall be contacted.

NOTE 5: This step is not necessary in a deployment with a single PCF.

24. [Optional] The PCF may retrieve authorization information for the MBS session from the UDR (see clause 6.10.2 of 3GPP TS 23.247 V18.1.0) and takes it into account for the subsequent authorization and QoS allowance check.

NOTE 6: This step is not necessary if authorization data are stored in the PCF.

25. The PCF determines whether the request is authorized and if the request is authorized, the PCF derives the required QoS parameters based on the received MBS Service Information and determines whether this QoS is allowed. If the required QoS is allowed, the PCF generates the policy information for the MBS session (as defined in clause 6.10) and stores it together with the MBS session ID.

26. If the request is authorized and the required QoS is allowed the PCF registers at the BSF that it handles the MBS session by using Nbsf_management_Register Request (MBS session ID, PCF ID). It provides an identifier that the policy association is for MBS and the MBS session ID, its own PCF ID and optionally its PCF set ID.

NOTE 7: This step is not necessary in a deployment with a single PCF.

27. The PCF responds with Npcf_MBSPolicyControl_Create Response ([policy information for the MBS session (as defined in clause 6.10 of 3GPP TS 23.247 V18.1.0)], Result indication).

If the request is not authorized or the required QoS is not allowed, the PCF indicates so in the response to the MB-SMF which in turn informs the AF about it (by sending the Nmbsmf_MBSSession_Create response) and ends this procedure.

If another PCF is serving the MBS session, the PCF indicates that another PCF serving the MBS session shall be contacted and provides an ID of that other PCF. The MB-SMF then repeats step 22 towards that other PCF.

28-37: Same as steps 14-22 in FIG. 7.1.1.2-1 of 3GPP TS 23.247 V18.1.0.

In step 30, the MB-SMF includes binding ID in Nmbsmf_MBSSession Create response for location dependent MBS service.

NOTE 7a: if AF/NEF/MBSF has the mechanism to associate the area session ID and the binding ID when receiving Nmbsmf_MBSSession_Create response, there is no need to send back the binding ID in the response for a location dependent MBS service.

NOTE 8: Steps 33-36 can be executed in parallel to step 32.

Some messages of FIGS. 5-6, 7A and 7B may be same as the corresponding messages as described in 3GPP TS 23.247 V18.1.0. Some messages of FIGS. 5-6, 7A and 7B are amended according to some embodiments of the present disclosure.

In an embodiment, clause 6.10 of of 3GPP TS 23.247 V18.1.0 may be amended as following.

6.10 Policy control for Multicast and Broadcast services

### 6.10.1 General

The policy and charging control framework as defined in TS 23.503 [7] applies to Multicast and Broadcast services in the following aspects:
MBS session binding: MBS session binding is the association of an AF Session information to one and only one MBS session. The PCF shall perform the session binding based on the MBS session ID, i.e. TMGI or source specific IP multicast address. For location dependent MBS session, area session policy ID is used together with MBS session ID to associate the AF Session information with the location dependent MBS session in a specific MBS service area.
QoS Flow binding: For an MBS session, QoS Flow binding is the association of a PCC rule to a QoS Flow within an MBS session. The MB-SMF performs QoS Flow binding for an MBS session in the same way as the SMF for a PDU Session.
MBS policy information consists of:
   PCC rules for MBS session are used to provide policy for QoS flows: The following PCC rule parameters defined in Table 6.3.1 of TS 23.503 [7] are applicable for MBS:
   Rule identifier.
   Service data flow detection: Precedence, Service data flow template (only for IP PDU traffic).
   Policy Control: 5G QoS Identifier (5QI), DL-maximum bitrate, DL-guaranteed bitrate, ARP, Priority Level, Averaging Window, Maximum Data Burst Volume.
Policy information can also be applicable for an entire MBS session. The following parameters defined for a PDU session in Table 6.4.1 of TS 23.503 [7] are applicable for an entire MBS session:
   Authorized Session-AMBR.
   Explicitly Signalled QoS Characteristics.
Policy Control Request Triggers for MBS session are used to define the conditions when the MB-SMF shall interact again with the PCF to request an update of the policy information for the MBS session by providing information on the condition(s) that have been met. The following Policy Control Request Triggers are defined for MBS:
   MBS session Update.

In an embodiment, clause 9.1.3.6 of of 3GPP TS 23.247 V18.1.0 may be amended as following.

9.1.3.6 Nmbsmf_MBSSession_Create service operation

Service operation name: Nmbsmf_MBSSession Create

Description: Create a new multicast session or broadcast session, or for a location dependent MBS session, the part of the MBS session within a service area. Optionally subscribe to notifications for this MBS session.

Input, Required: Mbs Session Id (ssm or Tmgi) or Tmgi Allocation Request, Mbs Service Type (multicast or broadcast).

Input, Optional: DNN, S-NSSAI, MBS service area, area session policy binding ID, MBS Service Information (as defined in clause 6.14), Input Transport Address Request, MBS start time, MBS termination time. For a multicast session, indication that any UE may join, multicast session security context. For a broadcast session, MBS FSA ID(s). For subscription to notifications event ID(s), Notification Target Address, Request for location dependent MBS session, Associated Session ID for resource sharing across broadcast MBS Sessions during network sharing.

### Output, Required: Result Indication.

Output, Optional: TMGI, NID, Expiry Time of the TMGI, Cause, MB-UPF tunnel info, MBS FSA ID(s), area session ID, area session policy binding ID.

Area session policy binding ID is provided for location dependent MBS service by the AF/NEF/MBSF when interacting with the PCF, see description of FIG. 5.

In an embodiment, clause 9.2.2.2 of of 3GPP TS 23.247V 18.1.0 may be amended as following.

9.2.2.2 Npcf_MBSPolicyControl_Create service operation

Service operation name: Npcf_MBSPolicyControl_Create

Description: The NF Service Consumer can request the creation of a MBS Policy Association and provide relevant parameters about the MBS session to the PCF.

Inputs, Required: MBS session ID.

Inputs, Optional: MBS Service Information (as defined in clause 6.14), area session policy ID, DNN, S-NSSAI.

Outputs, Required: Success or Failure. In the case of Success, MBS Policy Association ID and Policy information for the MBS session (as defined in clause 6.10).

Outputs, Optional: In the case of Failure, the Service Information that can be accepted by the PCF. In the case of Failure, indication that another PCF shall be contacted and an ID of that other PCF.

Area session policy ID is provided for location dependent MBS service. Area session policy ID is set to area session ID if the AF/NEF/MBSF does not interact with the PCF or set to area session policy binding ID if the AF/NEF/MBSF interacts with the PCF, see description of FIG. 5.

In an embodiment, clause 9.2.3.2 of of 3GPP TS 23.247 V18.1.0 may be amended as following.

9.2.3.2 Npcf_MBSPolicyAuthorization_Create service operation

Service operation name: Npcf_MBSPolicyAuthorization_Create

Description: Authorize the request, and optionally determines and installs MBS Policy Control Data according to the information provided by the NF Consumer.

Inputs, Required: MBS session ID.

Inputs, Optional: DNN if available, S-NSSAI if available, MBS Service Information (as defined in clause 6.14), area session binding ID.

Outputs, Required: Success (application session context) or Failure (reason for failure).

Outputs, Optional: In the case of Failure, the MBS Service Information that can be accepted by the PCF.

Area session policy binding ID is provided for location dependent MBS service by the AF/NEF/MBSF when interacting with the PCF, see description of FIG. 5.

Many advantages may be achieved by applying the proposed solution according to embodiments of the present disclosure. In some embodiments herein, it can avoid the failure cases of creating application session context and/or policy association. In some embodiments herein, the policy association created by MBS policy control create request with the policy authorized in MBS policy authorization create request for the same area session of a location dependent MBS service can be well bound. In some embodiments herein, there is no significant complexity added to the current procedure. Part of the available information such as area session ID can be reused in the framework. In some embodiments herein, it has good backward compatibility. The embodiments herein are not limited to the features and advantages mentioned above. A person skilled in the art will recognize additional features and advantages upon reading the following detailed description.

In some embodiments herein, it introduces the area session policy binding ID together with area session policy ID to address at least one of the above identified problems. It can avoid the failure cases of creating application session context and/or policy association. The policy association created by MBS policy control create request with the policy authorized in MBS policy authorization create request for the same area session of a location dependent MBS service can be well bound. There is no significant complexity added to the current procedure. Part of the available information such as area session ID can be reused in the framework. It has good backward compatibility.

In some embodiments herein, it uses the MBS Service Area as a unique identifier to address at least one of the above identified problems. It can avoid the failure cases of creating application session context and/or policy association. The policy association created by MBS policy control create request with the policy authorized in MBS policy authorization create request for the same area session of a location dependent MBS service can be well bound. It may have the fewest effects on the procedure. It can use the currently available data within the framework. It is a backward-compatible solution.

In some embodiments herein, it introduces a generic identifier that uniquely identifies a session towards a specific MBS service area with the same MBS session ID to address at least one of the above identified problems. It can avoid the failure cases of creating application session context and/or policy association. The policy association created by MBS policy control create request with the policy authorized in MBS policy authorization create request for the same area session of a location dependent MBS service can be well bound. There is no significant complexity added to the current procedure. A completely new identifier can be defined with the most straightforward format. It has a good backward compatibility.

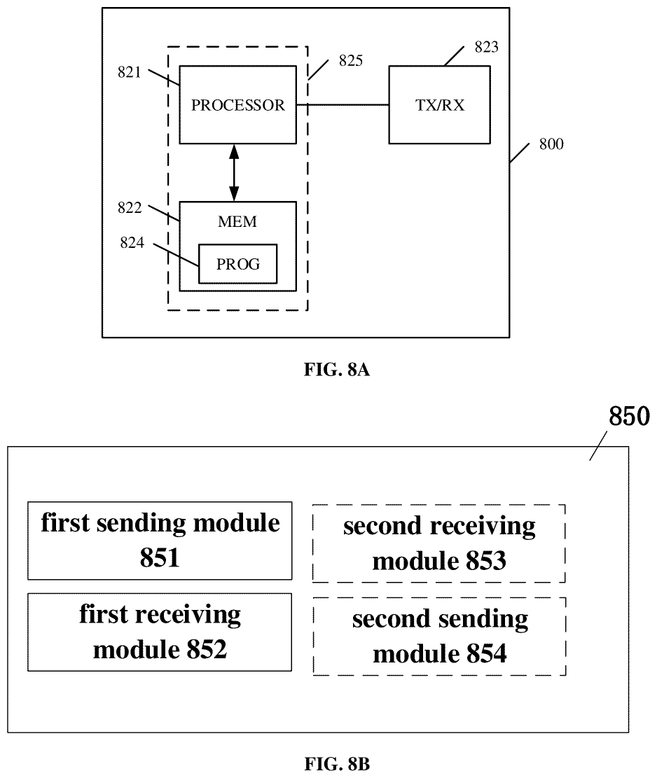

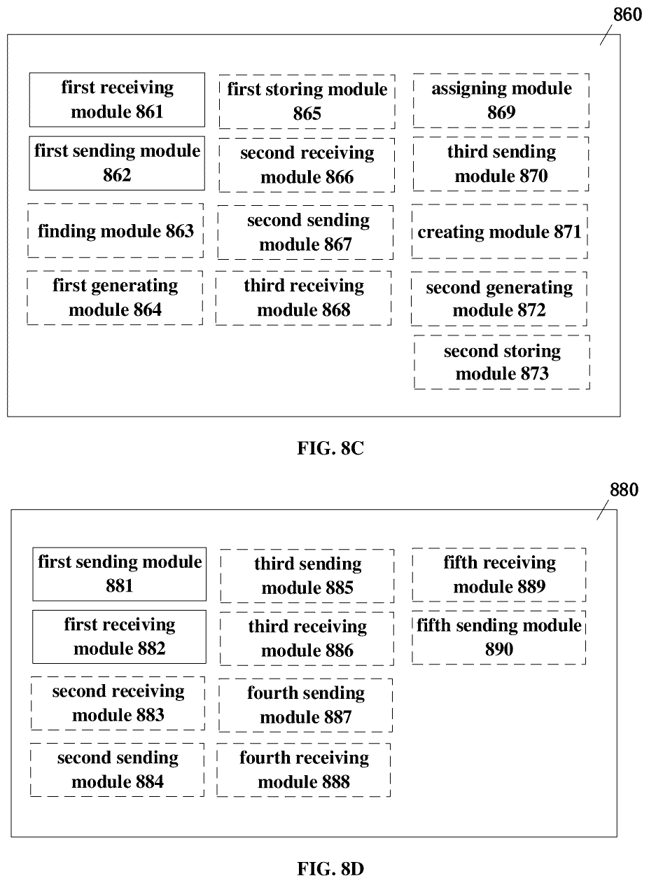

FIG. 8A is a block diagram showing an apparatus suitable for practicing some embodiments of the disclosure. For example, the MB-SMF, the PCF or the network function described above may be implemented as or through the apparatus 800.

The apparatus 800 may comprise at least one processor 821, such as a digital processor (DP), and at least one memory (MEM) 822 coupled to the processor 821. The apparatus 800 may further comprise a transmitter TX and receiver RX 823 coupled to the processor 821. The MEM 822 stores a program (PROG) 824. The PROG 824 may include instructions that, when executed on the associated processor 821, enable the apparatus 800 to operate in accordance with the embodiments of the present disclosure. A combination of the at least one processor 821 and the at least one MEM 822 may form processing means 825 adapted to implement various embodiments of the present disclosure.

Various embodiments of the present disclosure may be implemented by computer program executable by one or more of the processor 821, software, firmware, hardware or in a combination thereof.

The MEM 822 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 821 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the MB-SMF, the memory 822 contains instructions executable by the processor 821, whereby the MB-SMF operates according to any of the methods performed by the MB-SMF as described above.

In an embodiment where the apparatus is implemented as or at the PCF, the memory 822 contains instructions executable by the processor 821, whereby the PCF operates according to any of the methods performed by the PCF as described above.

In an embodiment where the apparatus is implemented as or at the network function, the memory 822 contains instructions executable by the processor 821, whereby the network function operates according to any of the methods performed by the network function as described above.

FIG. 8B is a block diagram showing an MB-SMF according to an embodiment of the disclosure. As shown, the MB-SMF 850 may comprise a first sending module 851 configured to send a multicast/broadcast service (MBS) policy control create request for a location dependent MBS session to a policy control function (PCF). The MB-SMF 850 may comprise a first receiving module 852 configured to receive an MBS policy control create response for the location dependent MBS session from the PCF. The MBS policy control create request may comprise a MBS session identifier (ID) and first information. The first information and the MBS session ID may be used to uniquely identify an MBS session towards a specific MBS service area of a location dependent MBS session, and/or create a policy association for the location dependent MBS session corresponding to the MBS session ID and the first information, and/or differentiate different location based services provided via the location dependent MBS session with a same MBS session ID, and/or associate application function (AF) session information with the location dependent MBS session in a specific MBS service area, and/or uniquely identify policy information for the location dependent MBS session corresponding to the MBS session ID and the first information.

In an embodiment, the MB-SMF 850 may further comprise a second receiving module 853 configured to receive an MBS session create request for the location dependent MBS session from a network function.

In an embodiment, the MB-SMF 850 may further comprise a second sending module 854 configured to send an MBS session create response for the location dependent MBS session to the network function.

FIG. 8C is a block diagram showing a PCF according to an embodiment of the disclosure. As shown, the PCF 860 may comprise a first receiving module 861 configured to receive an MBS policy control create request for a location dependent MBS session from an MB-SMF. The PCF 860 may further comprise a first sending module 862 configured to send an MBS policy control create response for the location dependent MBS session to the MB-SMF. The MBS policy control create request may comprise an MBS session ID and first information. The first information and the MBS session ID may be used to uniquely identify an MBS session towards a specific MBS service area of a location dependent MBS session, and/or create a policy association for the location dependent MBS session corresponding to the MBS session ID and the first information, and/or differentiate different location based services provided via the location dependent MBS session with a same MBS session ID, and/or associate application function (AF) session information with the location dependent MBS session in a specific MBS service area, and/or uniquely identify policy information for the location dependent MBS session corresponding to the MBS session ID and the first information, and/or bind the policy association with application session context for the location dependent MBS session corresponding to the MBS session ID and the first information.

In an embodiment, when the MBS policy control create request does not comprise MBS service information, the PCF 860 may comprise a finding module 863 configured to find policy information for the location dependent MBS session corresponding to the MBS session ID and the first information.

In an embodiment, when the MBS policy control create request comprises MBS service information and is authorized and at least one required quality of service (QOS) parameter derived based on the MBS service information is allowed, the PCF 860 may further comprise a first generating module 864 configured to generate policy information for the location dependent MBS session corresponding to the MBS session ID and the first information. The PCF 860 may further comprise a first storing module 865 configured to store the policy information for the location dependent MBS session corresponding to the MBS session ID and the first information together with the MBS session ID and the first information.

In an embodiment, the PCF 860 may further comprise a second receiving module 866 configured to receive an MBS policy authorization create request for the location dependent MBS session from a network function. The MBS policy authorization create request may comprise the second information and the MBS session ID and MBS service information. The PCF 860 may further comprise a second sending module 867 configured to send an MBS policy authorization create response for the location dependent MBS session to the network function. The second information and the MBS session ID may be used to uniquely identify an MBS session towards a specific MBS service area of a location dependent MBS session, and/or differentiate different location based services provided via the location dependent MBS sessions with a same MBS session ID, and/or associate application function (AF) session information with the location dependent MBS session in a specific MBS service area.

In an embodiment, the PCF 860 may further comprise a third receiving module 868 configured to receive an MBS policy authorization create request for the location dependent MBS session from a network function. The MBS policy authorization create request may comprise an MBS service area for a location dependent MBS service and the MBS session ID and MBS service information.

In an embodiment, the PCF 860 may further comprise an assigning module 869 configured to assign a unique area session policy binding ID for the MBS service area. The unique area session policy binding ID may be used as the second information.

In an embodiment, the PCF 860 may further comprise a third sending module 870 configured to send an MBS policy authorization create response for the location dependent MBS session to the network function. The MBS policy authorization create response may comprise the unique area session policy binding ID used as the second information.

In an embodiment, when the MBS policy authorization create request is authorized and at least one required QoS parameter derived based on the MBS service information is allowed, the PCF 860 may comprise a creating module 871 configured to create an application session context for the location dependent MBS session corresponding to the MBS session ID and the second information. The PCF 860 may comprise a second generating module 872 configured to generate policy information for the location dependent MBS session corresponding to the MBS session ID and the second information. The PCF 860 may comprise a second storing module 873 configured to store the policy information for the location dependent MBS session corresponding to the MBS session ID and the second information together with the MBS session ID and the second information.

FIG. 8D is a block diagram showing a network function according to an embodiment of the disclosure. As shown, the network function 880 may comprise a first sending module 881 configured to send an MBS session create request for a location dependent MBS session to an MB-SMF. The network function 880 may further comprise a first receiving module 882 configured to receive an MBS session create response for the location dependent MBS session from the MB-SMF. The MBS session create request may comprise second information and an MBS session ID. The second information and the MBS session ID may be used to uniquely identify an MBS session towards a specific MBS service area of a location dependent MBS session, and/or differentiate different location based services provided via the location dependent MBS session with a same MBS session ID, and/or associate application function (AF) session information with the location dependent MBS session in a specific MBS service area.

In an embodiment, when the network function is an NEF or an MBSF, the network function 880 may further comprise a second receiving module 883 configured to receive the MBS session create request for the location dependent MBS session from an AF. The network function 880 may further comprise a second sending module 884 configured to send the MBS session create response for the location dependent MBS session to the AF.

In an embodiment, the network function 880 may further comprise a third sending module 885 configured to send an MBS policy authorization create request for the location dependent MBS session to a PCF. The MBS policy authorization create request may comprise the second information and the MBS session ID and MBS service information. The network function 880 may further comprise a third receiving module 886 configured to receive an MBS policy authorization create response for the location dependent MBS session from the PCF. The second information and the MBS session ID may be used to create application session context for the location dependent MBS session corresponding to the MBS session ID and the second information.

In an embodiment, the network function 880 may further comprise a fourth sending module 887 configured to send an MBS policy authorization create request for the location dependent MBS session to a PCF. The MBS session create request may comprise an MBS service area for a location dependent MBS service and the MBS session ID and MBS service information. The network function 880 may further comprise a fourth receiving module 888 configured to receive an MBS policy authorization create response for the location dependent MBS session from the PCF. The MBS policy authorization create response may comprise a unique area session policy binding ID used as the second information. The second information and the MBS session ID may be used to create application session context for the location dependent MBS session corresponding to the MBS session ID and the second information.

In an embodiment, when the network function is an NEF or an MBSF, the network function 880 may further comprise a fifth receiving module 889 configured to receive the MBS policy authorization create request for the location dependent MBS session from an AF. The network function 880 may further comprise a fifth sending module 890 configured to send the MBS policy authorization create response for the location dependent MBS session to the AF.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the MB-SMF, the PCF or the network function may not need a fixed processor or memory, any computing resource and storage resource may be arranged from the MB-SMF, the PCF or the network function in the communication system. The introduction of virtualization technology and network computing technology may improve the usage efficiency of the network resources and the flexibility of the network.

Further, the exemplary overall commutation system including the terminal device (such as UE) and the network node (such as the MB-SMF, the PCF or the network function) will be introduced as below.

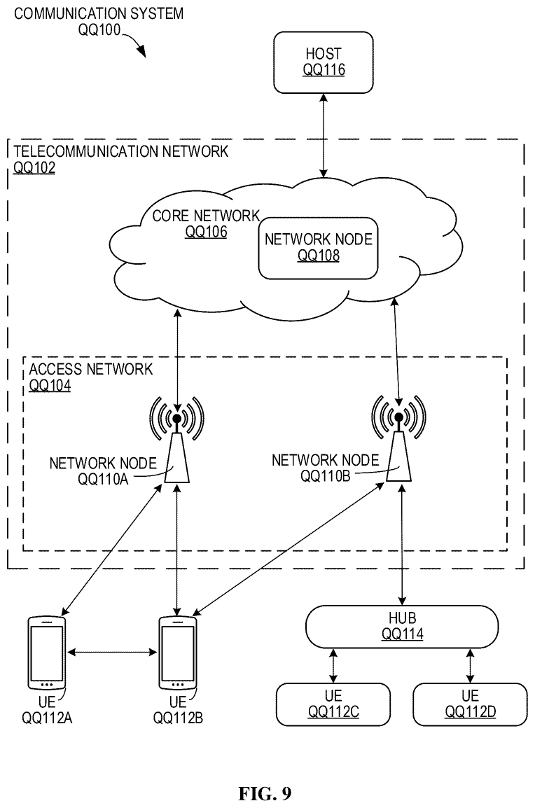

FIG. 9 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1,F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub-that is, a hub whose primary function is to route communications to/from the UEs from/to the network node QQ110b. In other embodiments, the hub QQ114 may be a non-dedicated hub-that is, a device which is capable of operating to route communications between the UEs and network node QQ110b, but which is additionally capable of operating as a communication start and/or end point for certain data channels.

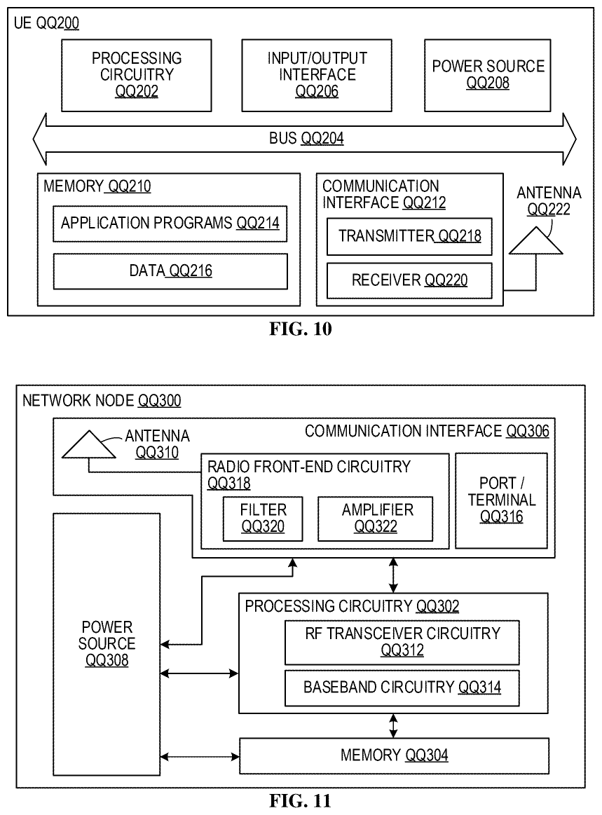

FIG. 10 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2 V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 11 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

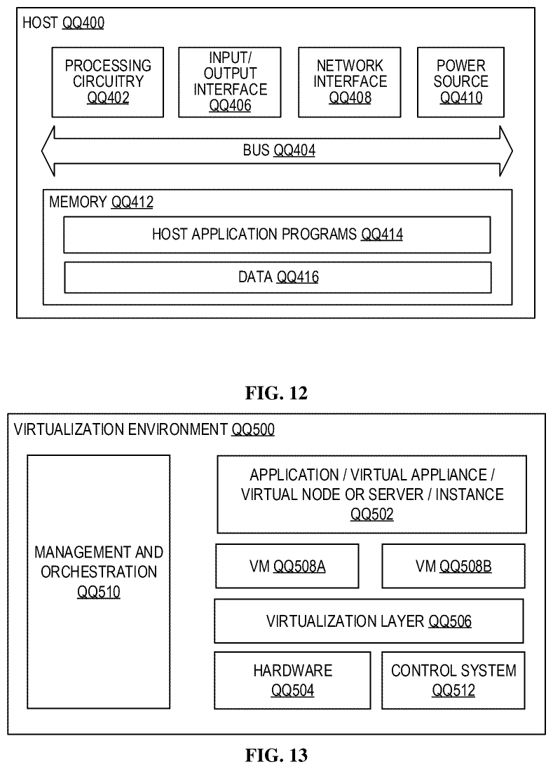

FIG. 12 is a block diagram of a host QQ400, which may be an embodiment of the host QQ116 of FIG. 9, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the terminal devices, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508A and QQ508B (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

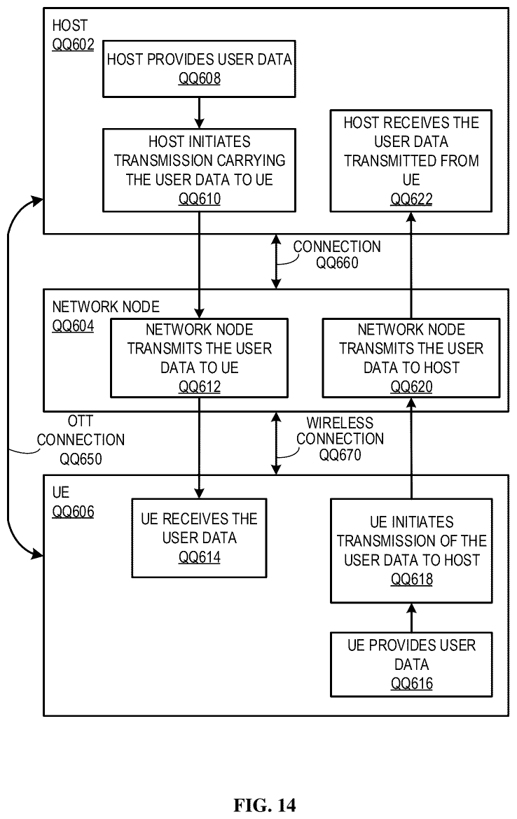

FIG. 14 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 9), network node (such as network node QQ110a of FIG. 9), and host (such as host QQ116 of FIG. 9 and/or host QQ400 of FIG. 12) discussed in the preceding paragraphs will now be described with reference to FIG. 14.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 9) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, in some embodiments herein, it can avoid the failure cases of creating application session context and/or policy association. In some embodiments herein, the policy association created by MBS policy control create request with the policy authorized in MBS policy authorization create request for the same area session of a location dependent MBS service can be well bound. In some embodiments herein, there is no significant complexity added to the current procedure. Part of the available information such as area session ID can be reused in the framework. In some embodiments herein, it has good backward compatibility.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Embodiment 1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations related to the network node as described above to transmit the user data from the host to the UE.

Embodiment 2. The host of the previous embodiment, wherein:
the processing circuitry of the host is configured to execute a host application that provides the user data; and
the UE comprises processing circuitry configured to execute a client application associated with the host application to receive the transmission of user data from the host.

Embodiment 3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the operations related to the network node as described above to transmit the user data from the host to the UE.

Embodiment 4. The method of the previous embodiment, further comprising, at the network node, transmitting the user data provided by the host for the UE.

Embodiment 5. The method of any of the previous 2 embodiments, wherein the user data is provided at the host by executing a host application that interacts with a client application executing on the UE, the client application being associated with the host application.

Embodiment 6. A communication system configured to provide an over-the-top (OTT) service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations related to the network node as described above to transmit the user data from the host to the UE.

Embodiment 7. The communication system of the previous embodiment, further comprising:
the network node; and/or
the user equipment.

Embodiment 8. The communication system of the previous 2 embodiments, wherein:
the processing circuitry of the host is configured to execute a host application, thereby providing the user data; and
the host application is configured to interact with a client application executing on the UE, the client application being associated with the host application.

Embodiment 9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations related to the network node as described above to receive the user data from the UE for the host.

Embodiment 10. The host of the previous 2 embodiments, wherein:
the processing circuitry of the host is configured to execute a host application, thereby providing the user data; and
the host application is configured to interact with a client application executing on the UE, the client application being associated with the host application.

Embodiment 11. The host of they of the previous 2 embodiments, wherein the initiating receipt of the user data comprises requesting the user data.

Embodiment 12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the operations related to the network node as described above to receive the user data from the UE for the host.

Embodiment 13. The method of the previous embodiment, further comprising at the network node, transmitting the received user data to the host.

Embodiment 14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform any of the operations related to the UE as described above to receive the user data from the host.

Embodiment 15. The host of the previous embodiment, wherein the cellular network further includes a network node configured to communicate with the UE to transmit the user data to the UE from the host.

Embodiment 16. The host of the previous 2 embodiments, wherein:
the processing circuitry of the host is configured to execute a host application, thereby providing the user data; and
the host application is configured to interact with a client application executing on the UE, the client application being associated with the host application.

Embodiment 17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations related to the UE as described above to receive the user data from the host.

Embodiment 18. The method of the previous embodiment, further comprising:
at the host, executing a host application associated with a client application executing on the UE to receive the user data from the UE.

Embodiment 19. The method of the previous embodiment, further comprising:
at the host, transmitting input data to the client application executing on the UE, the input data being provided by executing the host application,
wherein the user data is provided by the client application in response to the input data from the host application.

Embodiment 20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform any of the operations related to the UE as described above to transmit the user data to the host.

Embodiment 21. The host of the previous embodiment, wherein the cellular network further includes a network node configured to communicate with the UE to transmit the user data from the UE to the host.

Embodiment 22. The host of the previous 2 embodiments, wherein:
the processing circuitry of the host is configured to execute a host application, thereby providing the user data; and
the host application is configured to interact with a client application executing on the UE, the client application being associated with the host application.

Embodiment 23. A method implemented by a host configured to operate in a communication system that further includes a network node and a user equipment (UE), the method comprising:
at the host, receiving user data transmitted to the host via the network node by the UE, wherein the UE performs any of the operations related to the UE as described above to transmit the user data to the host.

Embodiment 24. The method of the previous embodiment, further comprising:
at the host, executing a host application associated with a client application executing on the UE to receive the user data from the UE.

Embodiment 25. The method of the previous embodiments, further comprising:
at the host, transmitting input data to the client application executing on the UE, the input data being provided by executing the host application,
wherein the user data is provided by the client application in response to the input data from the host application.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1-13. (canceled)

14. A method performed by a policy control function, PCF, comprising:
receiving a multicast/broadcast session, MBS, policy control create request for a location dependent MBS session from a multicast/broadcast session management function, MB-SMF,
sending an MBS policy control create response for the location dependent MBS session to the MB-SMF,
wherein the MBS policy control create request comprises an MBS session identifier, ID, and first information,
wherein the first information and the MBS session ID are used to:
uniquely identify an MBS session towards a specific MBS service area of a location dependent MBS session, and/or
create a policy association for the location dependent MBS session corresponding to the MBS session ID and the first information, and/or
differentiate different location based services provided via the location dependent MBS session with a same MBS session ID, and/or
associate application function, AF, session information with the location dependent MBS session in a specific MBS service area, and/or
uniquely identify policy information for the location dependent MBS session corresponding to the MBS session ID and the first information, and/or
bind the policy association with application session context for the location dependent MBS session corresponding to the MBS session ID and the first information.

15. The method according to claim 14, wherein when the MBS policy control create request does not comprise MBS service information, the method further comprises:
finding policy information for the location dependent MBS session corresponding to the MBS session ID and the first information.

16. The method according to claim 14, wherein when the MBS policy control create request comprises MBS service information and is authorized and at least one required quality of service, QoS, parameter derived based on the MBS service information is allowed, the method further comprises:
generating policy information for the location dependent MBS session corresponding to the MBS session ID and the first information, and
storing the policy information.

17. The method according to claim 14, wherein the first information comprises an a binding ID or an area session policy ID.

18-20. (canceled)

21. The method according to claim 17, wherein the binding ID is assigned by at least one of an AF, a network exposure function, NEF, or a multicast/broadcast service function, MBSF, wherein the area session policy ID is assigned by at least one of an AF, an NEF, an MBSF or the PCF.

22. The method according to claim 17, wherein
if an MBS policy authorization create request for the location dependent MBS session has not been received by the PCF, the area session policy ID comprises an area session ID.

23-25. (canceled)

26. The method according to claim 14, further comprising:
receiving an MBS policy authorization create request for the location dependent MBS session from a network function, wherein the MBS policy authorization create request comprises an MBS service area for a location dependent MBS service and the MBS session ID and MBS service information;
assigning a unique area session policy ID for the MBS service area, wherein the unique area session policy ID is used as second information; and
sending an MBS policy authorization create response for the location dependent MBS session to the network function, wherein the MBS policy authorization create response comprises the unique area session policy ID used as the second information.

27. The method according to claim 26, wherein when the MBS policy authorization create request is authorized and at least one required QoS parameter derived based on the MBS service information is allowed, the method further comprises:
creating an application session context for the location dependent MBS session corresponding to the MBS session ID and the second information;
generating policy information for the location dependent MBS session corresponding to the MBS session ID and the second information; and
storing the policy information.

28. The method according to claim 26, wherein the network function comprises at least one of:
an AF,
a network exposure function, NEF, or
a multicast/broadcast service function, MBSF.

29-41. (canceled)

42. A PCF comprising:
a processor; and
a memory coupled to the processor said memory containing instructions executable by said processor whereby said PCF is operative to
receive an MBS policy control create request for a location dependent MBS session from an MB-SMF,
send an MBS policy control create response for the location dependent MBS session to the MB-SMF,
wherein the MBS policy control create request comprises an MBS session ID and first information,
wherein the first information and the MBS session ID are used to:
uniquely identify an MBS session towards a specific MBS service area of a location dependent MBS session, and/or
create a policy association for the location dependent MBS session corresponding to the MBS session ID and the first information, and/or
differentiate different location based services provided via the location dependent MBS session with a same MBS session ID, and/or
associate application function, AF, session information with the location dependent MBS session in a specific MBS service area, and/or
uniquely identify policy information for the location dependent MBS session corresponding to the MBS session ID and the first information, and/or
bind the policy association with application session context for the location dependent MBS session corresponding to the MBS session ID and the first information.

43-47. (canceled)

48. The method according to claim 26, wherein the second information comprises at least one of a binding ID or the area session policy ID.

49. The method according to claim 48, wherein the binding ID is assigned by at least one of an AF, a network exposure function, NEF, or a multicast/broadcast service function, MBSF.

50. The method according to claim 26, wherein the second information, comprised in the MBS policy authorization create response, is further received by the PCF from the MB-SMF as the first information comprised in the MBS policy control create request.
